(19) United States
(12) Patent Application Publication
(10) Pub. No.: US 2025/0097753 A1
(43) Pub. Date: Mar. 20, 2025

(54) SENSING MEASUREMENT METHOD AND APPARATUS, DEVICE, TERMINAL, AND STORAGE MEDIUM

(71) Applicant: VIVO MOBILE COMMUNICATION CO., LTD., Dongguan (CN)

(72) Inventors: Dajie JIANG, Dongguan (CN); Yannan YUAN, Dongguan (CN)

(73) Assignee: VIVO MOBILE COMMUNICATION CO., LTD., Dongguan (CN)

(21) Appl. No.: 18/963,726

(22) Filed: Nov. 28, 2024

Related U.S. Application Data
(63) Continuation of application No. PCT/CN2023/095818, filed on May 23, 2023.

(30) Foreign Application Priority Data
May 30, 2022 (CN) 202210602652.7

(51) Int. Cl. H04W 24/10; H04B 17/309; H04W 8/22; H04W 64/00

(52) U.S. Cl. CPC H04W 24/10; H04B 17/346; H04W 8/22; H04W 64/00

(57) ABSTRACT

A sensing measurement method and apparatus, a device, a terminal, and a storage medium are provided. The sensing measurement method includes: selecting, by a first device, a first terminal when a sensing terminal is determined to be changed; and sending, by the first device, a notification message to the first terminal, where the notification message is used to notify the first terminal of performing a sensing operation.

### CROSS-REFERENCE TO RELATED APPLICATIONS

This application is a continuation of International Application No. PCT/CN2023/095818, filed May 23, 2023, which claims priority to Chinese Patent Application No. 202210602652.7, filed May 30, 2022. The entire contents of each of the above-referenced applications are expressly incorporated herein by reference

### TECHNICAL FIELD

This application pertains to the field of communication technologies, and in particular, to a sensing measurement method and apparatus, a device, a terminal, and a storage medium.

### BACKGROUND

A future mobile communication system (such as a beyond 5^{th} generation (B5G) mobile communication system or a 6^{th} generation (6G) mobile communication system may have a sensing capability in addition to a communication capability. The sensing capability is that one or more devices with the sensing capability can sense information such as a direction, a distance, and/or a speed of a target object by sending and receiving a wireless signal, or detect, track, identify, or image a target object, an event, an environment, or the like. However, at present, a person skilled in the art is still in a discussion stage on how to realize the sensing measurement technology. A current discussion scheme is to use a fixed device to sense a sensing target, that is, a device participating in sensing is fixed, which leads to poor flexibility of sensing measurement.

### SUMMARY

Embodiments of this application provide a sensing measurement method and apparatus, a device, a terminal, and a storage medium.

According to a first aspect, a sensing measurement method is provided, where the method includes:
selecting, by a first device, a first terminal in a case that a sensing terminal is determined to be changed; and
sending, by the first device, a notification message to the first terminal, where the notification message is used to notify the first terminal of performing a sensing operation.

According to a second aspect, a sensing measurement method is provided, including:
receiving, by a first terminal, a notification message sent by a first device, where the notification message is used to notify the first terminal of performing a sensing operation; and
performing, by the first terminal, the sensing operation based on the notification message.

According to a third aspect, a sensing measurement method is provided, including:
performing, by a second terminal, a sensing operation; and
receiving, by the second terminal, a notification message for stopping the sensing operation sent by a first device.

According to a fourth aspect, a sensing measurement apparatus is provided, including:
a selecting module, configured to select a first terminal in a case that a sensing terminal is determined to be changed; and
a first sending module, configured to send a notification message to the first terminal, where the notification message is used to notify the first terminal of performing a sensing operation.

According to a fifth aspect, a sensing measurement apparatus is provided, including:
a receiving module, configured to receive a notification message sent by a first device, where the notification message is used to notify a first terminal of performing a sensing operation; and
an execution module, configured to perform the sensing operation based on the notification message.

According to a sixth aspect, a sensing measurement apparatus is provided, including:
an execution module, configured to perform a sensing operation; and
a first receiving module, configured to receive a notification message for stopping the sensing operation sent by a first device.

According to a seventh aspect, a communication device is provided, and the communication device is a first device, including a processor and a memory. The memory stores a program or an instruction that can be run on the processor, and when the program or the instruction is executed by the processor, the steps of the sensing measurement method at a first device side provided in the embodiments of this application are implemented.

According to an eighth aspect, a communication device is provided, and the communication device is a first device, including a processor and a communication interface, where the processor is configured to select a first terminal in a case that a sensing terminal is determined to be changed, and the communication interface is configured to send a notification message to the first terminal, where the notification message is used to notify the first terminal of performing a sensing operation.

According to a ninth aspect, a terminal is provided, and the terminal is a first terminal, including a processor and a memory, where the memory stores a program or an instruction that can be run on the processor, and when the program or the instruction is executed by the processor, the steps of the sensing measurement method at a first terminal side provided in the embodiments of this application are implemented.

According to a tenth aspect, a terminal is provided, and the terminal is a first terminal, including a processor and a communication interface, where the communication interface is configured to: receive a notification message sent by a first device, where the notification message is used to notify the first terminal of performing a sensing operation; and perform the sensing operation based on the notification message.

According to an eleventh aspect, a terminal is provided, and the terminal is a second terminal, including a processor and a memory, where the memory stores a program or an instruction that can be run on the processor, and when the program or the instruction is executed by the processor, the steps of the sensing measurement method at a second terminal side provided in the embodiments of this application are implemented.

According to a twelfth aspect, a terminal is provided, and the terminal is a second terminal, including a processor and a communication interface, where the communication interface is configured to: perform a sensing operation; and receive a notification message for stopping the sensing operation sent by a first device.

According to a thirteenth aspect, a sensing measurement system is provided, including a first device, a first terminal, and a second terminal, where the first device may be configured to perform the steps of the sensing measurement method according to the first aspect, the first terminal may be configured to perform the steps of the sensing measurement method according to the second aspect, and the second terminal may be configured to perform the steps of the sensing measurement method according to the third aspect.

According to a fourteenth aspect, a readable storage medium is provided. The readable storage medium stores a program or an instruction, and when the program or the instruction is executed by a processor, the steps of the method according to the first aspect, the second aspect, or the third aspect are implemented.

According to a fifteenth aspect, a chip is provided. The chip includes a processor and a communication interface. The communication interface is coupled to the processor. The processor is configured to run a program or an instruction, to implement the steps of the method according to the first aspect, the steps of the method according to the second aspect, or the steps of the method according to the third aspect.

According to a sixteenth aspect, a computer program/program product is provided. The computer program/program product is stored in a storage medium, and the computer program/program product is executed by at least one processor, to implement the steps of the method according to the first aspect, or the computer program/program product is executed by at least one processor, to implement the steps of the method according to the second aspect, or the computer program/program product is executed by at least one processor, to implement the steps of the method according to the third aspect.

In the embodiments of this application, the first device selects a first terminal in a case that a sensing terminal is determined to be changed; and the first device sends a notification message to the first terminal, where the notification message is used to notify the first terminal of performing a sensing operation. In this way, the first terminal is notified of performing the sensing operation, to change the sensing terminal, thereby improving flexibility of sensing measurement.

### BRIEF DESCRIPTION OF DRAWINGS

FIG. 1 is a block diagram of a wireless communication system to which embodiments of this application are applicable;

FIG. 2 is a schematic diagram of a scenario of sensing measurement according to an embodiment of this application;

FIG. 3 is a flowchart of a sensing measurement method according to an embodiment of this application;

FIG. 4 is a schematic diagram of SNR calculation according to an embodiment of this application;

FIG. 5 is a flowchart of another sensing measurement method according to an embodiment of this application;

FIG. 6 is a flowchart of still another sensing measurement method according to an embodiment of this application;

FIG. 7 is a schematic diagram of a scenario of sensing measurement according to an embodiment of this application;

FIG. 8 is a schematic diagram of another scenario of sensing measurement according to an embodiment of this application;

FIG. 9 is a schematic diagram of still another scenario of sensing measurement according to an embodiment of this application;

FIG. 10 is a structural diagram of a sensing measurement apparatus according to an embodiment of this application;

FIG. 11 is a structural diagram of another sensing measurement apparatus according to an embodiment of this application;

FIG. 12 is a structural diagram of still another sensing measurement apparatus according to an embodiment of this application;

FIG. 13 is a structural diagram of a communication device according to an embodiment of this application;

FIG. 14 is a structural diagram of another communication device according to an embodiment of this application; and

FIG. 15 is a structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} generation (6G) communication system.

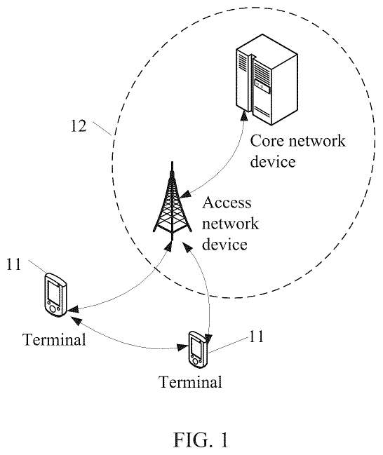

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer that is also referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a road side unit (RSU), smart household (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bracelet, a smart hand chain, a smart ring, a smart necklace, a smart bangle, a smart anklet, a smart helmet, a smart joystick, or the like), a smart wrist strap, a smart dress, and the like. It should be noted that a specific type of the terminal 11 is not limited in the embodiments of this application.

In the embodiments of this application, sidelink (SL) transmission may be performed between terminals 11, that is, data transmission may be directly performed on a physical layer between the terminals 11. The SL transmission between the terminals 11 may be broadcast, unicast, multicast, groupcast, or the like. In addition, all terminals of the SL transmission may be online or offline, or some terminals are online, and some terminals are offline.

The network side device 12 may include a radio access network device and a core network device. The radio access network device may also be referred to as a Radio Access Network (RAN), a radio access network function, or a radio access network unit. The radio access network device may include a base station, a Wireless Local Area Network (WLAN) access point, a Wireless Fidelity (Wi-Fi) node, or the like. The base station may be referred to as a NodeB, an Evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), a small cell, or another appropriate term in the field. As long as a same technical effect is achieved, the base station is not limited to a specified technical term. It should be noted that, in the embodiments of this application, only a base station in an NR system is used as an example, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), Unified Data Repository (UDR), a Home Subscriber Server (HSS), a Centralized network configuration (CNC), a Network Repository Function (NRF), a Network Exposure Function (NEF), a local NEF (Local NEF or L-NEF), a Binding Support Function (BSF), an Application Function (AF), a Network Data Analytics Function (NWDAF), and a Location Management Function (LMF).

In some implementations, the core network device may also be referred to as a sensing network function, a sensing network element, or a Sensing Management Function (Sensing MF), which may be on a side of the RAN or the core network, and refers to a network node that is in the core network and/or the RAN and that is responsible for at least one function such as sensing request processing, sensing resource scheduling, sensing information interaction, sensing data processing, and the like. The network node may be based on upgrade of AMF or LMF in the 5^{th} Generation (5G) mobile communication network, or may be another network node or a newly defined network node.

It should be noted that, in the embodiments of this application, only a core network device in an NR system is used as an example for description, and a specific type of the core network device is not limited.

In the embodiments of this application, the network side device and the terminal have a sensing capability, and can sense information about a target object, such as an orientation, a distance, and a speed by sending and receiving a wireless signal, or detect, track, identify, and image a target object, an event, an environment, and the like. Some sensing functions and application scenarios are shown in Table 1:

TABLE 1

| Communication | | |
|---|---|---|
| sensing category | Sensing function | Application scenario |
| Macro sensing type | Weather, air quality, and the | Meteorology, agriculture, and life |
| | like | services |
| | Traffic flow (intersections) | Smart city, intelligent transportation, |
| | and flow of people (subway | and business services |
| | entrances) | |
| | Target tracking, ranging, | Many application scenarios for |
| | speed measurement, | conventional radars |
| | contours, and the like | |
| | Environment reconstruction | Intelligent driving and navigation |
| | | (car/unmanned aerial vehicles), smart |
| | | city (3 Dimensions (3D) map), and |
| | | network planning and optimization |
| Fine sensing type | Action, posture, and | Intelligent interaction of smartphones, |
| | expression recognition | games, and smart household |
| | Heartbeat, breathing, and | Health and medical care |
| | the like | |
| | Imaging, material detection, | Security inspection, industry, |
| | component analysis, and the | biological medicine, and the like |
| | like | |

It should be noted that the sensing category shown in the foregoing Table 1 is merely an example for description, and a sensing measurement category is not limited in the embodiments of this application.

In addition, the embodiments of this application may be applied to a scenario of integrated sensing and communication. The integrated sensing and communication means that in a same system, a design of integrated communication and sensing functions is implemented through spectrum sharing and hardware sharing. When information is transmitted, the system can sense information such as a direction, a distance, and a speed, and detect, track, and identify a target device or an event. A communication system and a sensing system cooperate with each other, to improve overall performance and bring better service experience.

For example, integration of communication and radar is typical application of integrated sensing and communication (communication sensing integration), and integration of communication and radar systems can bring many advantages, such as reducing costs, reducing size, reducing power consumption, improving spectrum efficiency, and reducing mutual interference, thus improving overall performance of the system.

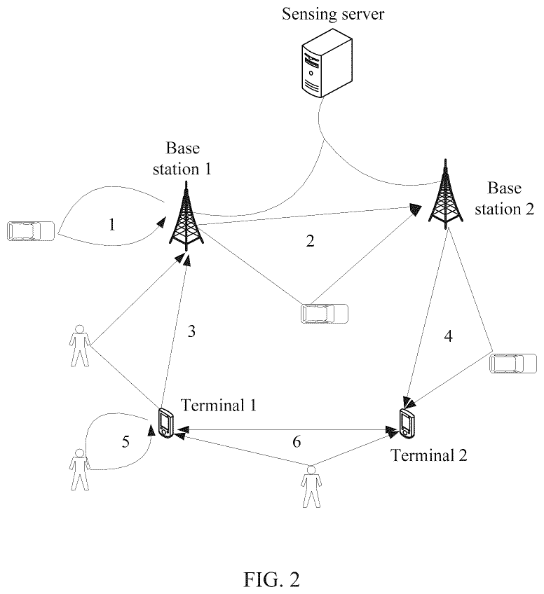

In the embodiments of this application, based on different sending nodes and receiving nodes of a sensing signal, it may include, but is not limited to 6 sensing links as shown in FIG. 2. It should be noted that in FIG. 2, each sensing link is described by using one sending node and one receiving node as an example. In an actual system, different sensing links may be selected according to different sensing requirements, each sensing link may have one or more sending nodes and receiving nodes, and the actual sensing system may include a variety of different sensing links. In addition, people and cars are used as an example to describe sensing objects in FIG. 2, and there may be more sensing objects in the actual system.

Sensing link 1: base station echo sensing. In this manner, a base station sends a sensing signal and obtains a sensing result by receiving an echo of the sensing signal.

Sensing link 2: air interface sensing between base stations. In this manner, base station 2 receives a sensing signal sent by base station 1, and obtains a sensing result.

Sensing link 3: uplink air interface sensing. In this manner, a base station receives a sensing signal sent by a terminal, and obtains a sensing result.

Sensing link 4: downlink air interface sensing. In this manner, a terminal receives a sensing signal sent by a base station, and obtains a sensing result.

Sensing link 5: terminal echo sensing. In this manner, a terminal sends a sensing signal and obtains a sensing result by receiving an echo of the sensing signal.

Sensing link 6: Sidelink sensing between terminals. For example, terminal 2 receives a sensing signal sent by terminal 1, and obtains a sensing result, or terminal 1 receives a sensing signal sent by terminal 2, and obtains a sensing result.

In some embodiments, a procedure of a sensing service may include:

A first communication device receives a sensing requirement from a second communication device, and determines first information based on the sensing requirement; or a first communication device receives first information from a second communication device.

The first communication device may be a terminal or a network side device, and the second communication device may be a terminal or a network side device.

In some implementations, the first information includes parameter information and/or resource information of a sensing signal.

In some implementations, if the first communication device receives the first information from the second communication device, before this step, the second communication device determines the first information based on the sensing requirement.

In some implementations, that the second communication device determines or receives the sensing requirement includes at least one of the following:
the sensing requirement comes from an external application, in this case, AF sends the sensing requirement to NEF and then to AMF, and AMF selects a sensing management function (SensingMF) and sends the sensing requirement to SensingMF;
the sensing requirement comes from an external application, AF sends the sensing requirement to NEF, and NEF selects SensingMF and sends the sensing requirement to SensingMF;
the sensing requirement may also come from a base station and/or a terminal, in this case the base station and/or the terminal sends the sensing requirement to AMF, and AMF selects SensingMF and sends the sensing requirement to SensingMF;
the sensing requirement may also come from regulatory authorities, in this case the regulatory authorities send the sensing requirement to AMF, and AMF selects SensingMF and sends the sensing requirement to SensingMF; or the regulatory authorities directly send the sensing requirement to SensingMF; or the regulatory authorities send the sensing requirement to a network management system of an operator, and then the network management system sends the sensing requirement to SensingMF, or sends the sensing requirement to SensingMF through AMF; or

AF, the base station, or the terminal directly sends the sensing requirement to SensingMF (without forwarding through AMF).

In some implementations, the first communication device sends the sensing requirement to a third communication device.

In some implementations, the first communication device or the second communication device sends a sensing measurement quantity and measurement configuration information that the third communication device needs to feed back to the third communication device, where before this step, the first communication device receives the sensing measurement quantity that the third communication device needs to feed back from the second communication device; or the first communication device determines a sensing measurement quantity that the third communication device needs to feed back, for example, the first communication device determines, based on a second requirement, the sensing measurement quantity that the third communication device needs to feed back.

In some implementations, the first communication device sends second information to the third communication device; and the second information includes parameter information and/or resource information of the sensing signal, and the second information may be the same as or different from the first information.

In some implementations, the first communication device sends a first sensing signal corresponding to the first information to the third communication device.

In some implementations, the third communication device detects the first sensing signal, to obtain a first sensing measurement quantity.

In some implementations, the third communication device sends the first sensing measurement quantity to the first communication device or the second communication device based on feedback configuration information of the sensing measurement quantity, or the third communication device obtains a sensing result based on the first sensing measurement quantity, and sends the sensing result to the first communication device or the second communication device.

If the third communication device is a base station device, the third communication device sends the first sensing measurement quantity or the sensing result to the second communication device; if the third communication device is a terminal, the third communication device sends the first sensing measurement quantity or the sensing result to the first communication device; and then, the first communication device sends the first sensing measurement quantity or the sensing result to the second communication device. It should be noted that the third communication device may send label information corresponding to the first sensing measurement quantity (for example, a label of a sensing signal corresponding to the sensing measurement quantity, a time label of the sensing measurement quantity, a frequency label, a label of a base station or a TRP that sends the sensing signal, a label of an antenna port that sends the sensing signal, a receiving antenna label of the third communication device, or the like) to the first communication device or the second communication device.

In some implementations, if the third communication device sends the first sensing measurement quantity to the first communication device or the second communication device, a next step is that the first communication device or the second communication device obtains a sensing result based on the first sensing measurement quantity.

In some implementations, after the first communication device obtains a sensing result, the first communication device sends the sensing result to the second communication device, and the second communication device sends the sensing result to a sensing requirement side (such as
an external application, a base station, and a terminal); or after the second communication device obtains the sensing result, the second communication device sends the sensing result to the sensing requirement side.

In the embodiments of this application, the parameter information of the sensing signal (or the first signal) may include at least one of the following:
a waveform, for example, Orthogonal frequency division multiplex (OFDM), Single-Carrier Frequency-Division Multiple Access (SC-FDMA), Orthogonal Time Frequency Space (OTFS), a Frequency Modulated Continuous Wave (FMCW), a pulse signal, or the like;
a subcarrier spacing: for example, a subcarrier spacing of 30 KHz of an OFDM system;
a guard interval: a time interval between a moment at which sending of a signal ends and a moment at which a latest echo signal of the signal is received. The parameter is proportional to a maximum sensing distance, and for example, may be calculated by using 2dmax/c, where dmax is a maximum sensing distance (belonging to a sensing requirement). For example, for a self-transmit self-receive sensing signal, dmax represents a maximum distance from a transmitting receiving point of the sensing signal to a signal transmitting point. In some cases, an OFDM signal Cyclic Prefix (CP) may function as a minimum guard interval, where c is the speed of light;
a bandwidth, where the parameter is inversely proportional to a distance resolution and may be obtained by using c/2/delta_d, where delta_d is the distance resolution (which belongs to a sensing requirement);
burst duration: the parameter is inversely proportional to a rate resolution (which belongs to a sensing requirement), and the parameter is a time span of the sensing signal and is mainly used to calculate a Doppler frequency shift; and the parameter may be calculated by using c/2/delta_v/fc, where delta_v is a speed resolution, and fc is a signal carrier frequency or a center frequency of a signal;
a time domain interval: the parameter may be calculated by using c/2/fc/v_range, where v_range is a maximum rate minus a minimum speed (which belongs to a sensing requirement); and the parameter is a time interval between two adjacent sensing signals;
power information for sending a signal: for example, including a transmit power, a peak power, an average power, a total power, a power spectral density, an equivalent isotropically radiated power (EIRP), a power of each port, and the like. For example, one value of the transmit power is taken every 2 dBm from −20 dBm to 23 dBm;
a signal format, for example, a Sounding Reference Signal (SRS), a Demodulation Reference Signal (DMRS), a Positioning Reference Signal (PRS), or the like, or another predefined signal, a related sequence format (the sequence format is associated with sequence content, a sequence length, or the like), and other information;
a signal direction, for example, a direction or beam information of the sensing signal;
a beam information or Quasi co-location (QCL) relationship: for example, the sensing signal includes a plurality of resources, and each of the resources is QCL with one Synchronization Signal Block (SSB), where QCL includes Type A, Type B, Type C, or Type D; or
an antenna configuration parameter (suitable for a multi-antenna device to receive and transmit a sensing signal): for example, at least one of the following: a transmit antenna orthogonal mode (Time division multiplexing (TDM)/code division multiplexing (CDM)/frequency division multiplexing (FDM)/doppler division multiplex (DDM), and the like), a quantity of antenna ports, a quantity of antenna units, a distance between antenna units, a quantity of receiving channels, a quantity of transmit channels, a quantity of transmit antennas, or a quantity of (maximum) uplink or downlink Multiple Input Multiple Output (MIMO) layers.

In the embodiments of this application, the resource information of the sensing signal may include at least one of the following:
a time resource, for example, an index of a slot or a symbol index of the slot in which the sensing signal is located, where the time resource may include two types, one is a one-time time resource, for example, a symbol sends an omnidirectional first signal, and the other is non-one-time time resources, for example, a plurality of groups of periodic time resources or discontinuous time resources (which may include a start time and an end time), each group of periodic time resources send sensing signals in a same direction, and beam directions on different groups of periodic time resources are different; or
a frequency resource, including a center frequency, a bandwidth, a resource block (RB), a subcarrier, or the like of the sensing signal.

In the embodiments of this application, the sensing requirement may include at least one of the following:
a sensing target region: refers to a location region that a sensing object (also referred to as a sensing target) may exist, or a location region that needs imaging or three-dimensional reconstruction;
a sensing object type: sensing objects are classified based on possible motion characteristics of the sensing objects, and each sensing object type includes information such as a motion speed, a motion acceleration, a typical radar cross-section (RCS), and the like of a typical sensing object; or
sensing quality of service (QoS): a performance indicator for sensing a sensing target region or a sensing object, which may include at least one of the following:
a sensing resolution, which may be further divided into: a ranging resolution, an angle measurement resolution, a speed measurement resolution, an imaging resolution, and the like;
sensing accuracy, which may be further divided into: ranging accuracy, angle measurement accuracy, speed measurement accuracy, positioning accuracy, and the like;
a sensing range: which may be further divided into: a ranging range, a speed measurement range, an angle measurement range, an imaging range, and the like;
a sensing delay, such as a time interval from sending a sensing signal to obtaining a sensing result, or a time interval from initiating a sensing requirement to obtaining a sensing result;
a sensing update rate, such as a time interval between two times of adjacent sensing performing and sensing result obtaining;
a detection probability, such as a probability of being correctly detected in the presence of a sensing object; or
a false alarm probability, such as a probability that a sensing target is incorrectly detected in the absence of a sensing object.

In the embodiments of this application, the sensing measurement quantity may include the following four categories:
a first-level measurement quantity (a received signal/original channel information), including: a complex result, an amplitude/phase, and an I-channel/Q-channel of a received signal/channel response, and an operation result thereof (an operation includes an addition/subtraction/multiplication/division, a matrix addition/subtraction/multiplication, a matrix transposition, a triangular relationship operation, a square root operation, a power operation, a threshold detection result and a maximum/minimum value extraction result of the operation result, and the like; and the operation further includes Fast Fourier Transform (FFT)/Inverse Fast Fourier Transform (IFFT), Discrete Fourier Transform (DFT)/Inverse Discrete Fourier Transform (IDFT), two-dimensional FFT (2D-FFT), three-dimensional FFT (3D-FFT), matched filtering, autocorrelation calculation, wavelet transform, digital filtering, a threshold detection result and a maximum/minimum value extraction result of the operation result, and the like);
a second-level measurement quantity (a basic measurement quantity), including: a delay, Doppler, an angle, an intensity, and multidimensional combination representation thereof;
a third-level measurement quantity (a basic attribute/state), including: a distance, a speed,
an orientation, a spatial location, and an acceleration; and
a fourth-level measurement quantity (an advanced attribute/state), including: whether a target exists, a trajectory, an action, an expression, a vital sign, a quantity, an imaging result, weather, air quality, a shape, material, and composition.

In some implementations, the sensing measurement quantity may further include corresponding label information, for example, at least one of the following:
identification information of a sensing signal;
identification information of a sensing measurement configuration;
sensing service information (for example, a sensing service identifier (ID));
a data subscription ID;
usage of a measurement quantity (communication, sensing, and communication and sensing);
time information;
sensing node information (for example, a User Equipment (UE) ID, a node location, and a device orientation);
sensing link information (for example, a sensing link sequence number and a transceiver node identifier);
description information of a measurement quantity, a form such as an amplitude, a phase, and a complex number, and resource information such as an antenna/antenna pair/antenna group, a Physical Resource Block (PRB), and a symbol; or
measurement quantity indicator information, such as a Signal to Noise Ratio (SNR) and a sensing SNR.

In the embodiments of this application, the measurement configuration information may include at least one of the followings:
identification information of a sensing signal corresponding to a measurement quantity, such as sensing signal information corresponding to a sensing measurement quantity, time information and frequency information of the sensing measurement quantity, information about a base station or a TRP for sending the sensing signal, information about an antenna port for sending the sensing signal, information about a receiving antenna of a third device; or
a measurement cycle, and the like.

In the embodiments of this application, the sensing result may include at least one of the following:
at least one of a shape of the sensing target, 2D/3D environment reconstruction, a spatial location, an orientation, a displacement, a moving speed, or an acceleration;
radar-like sensing for speed measurement, ranging, and angle measurement/imaging of a target object;
whether people/objects exist; or
a sensing target such as an action, a gesture, a breathing frequency, a heartbeat frequency, sleep quality, and the like of a human.

In the embodiments of this application, the feedback configuration information of the sensing measurement quantity may include at least one of the following:
feeding back a time domain resource of a target sensing measurement quantity;
feeding back a frequency domain resource of the target sensing measurement quantity; feeding back an antenna domain resource of the target sensing measurement quantity; or feeding back a granularity or a step of the target sensing measurement quantity.

In the embodiments of this application, the sensing signal may be a signal with only a sensing function but no communication function, such as a synchronization signal or a reference signal in an LTE/NR system, this type of signal is based on a pseudo-random sequence, including an m sequence, a Zadoff-Chu sequence, a Gold sequence, and the like. The sensing signal may also be a single frequency Continuous Wave (CW), a Frequency Modulated CW (FMCW), an ultra-wideband Gaussian pulse, and the like that are commonly used in radar. The sensing signal may also be a newly designed dedicated sensing signal with good correlation characteristics and a low peak-to-average power ratio (PAPR), or a newly designed integrated sensing and communication signal with both a sensing function and a communication function. In the embodiments of this application, both the sensing signal and the integrated sensing and communication signal are referred to as the sensing signal.

The following describes in detail the sensing measurement method and apparatus, a device, a terminal, and a storage medium provided in the embodiments of this application through some embodiments and application scenarios thereof with reference to the accompanying drawings.

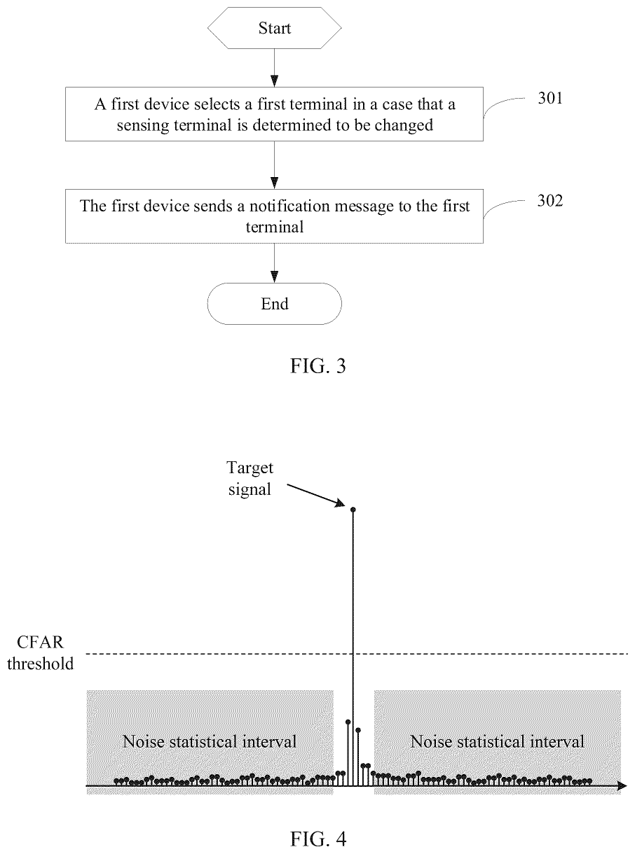

Referring to FIG. 3, FIG. 3 is a flowchart of a sensing measurement method according to an embodiment of this application. As shown in FIG. 3, the method includes the following steps.

Step 301: A first device selects a first terminal in a case that a sensing terminal is determined to be changed.

The changing of the sensing terminal may be changing an existing sensing terminal to a new sensing terminal, for example, in a case that a second terminal is a terminal currently performing a sensing operation, the changing of the sensing terminal is changing the second terminal to the first terminal; or the changing of the sensing terminal may be adding a new sensing terminal, for example, in a case that the second terminal is the terminal currently performing a sensing operation, the changing of the sensing terminal is adding the first terminal on the basis of the second terminal, that is, both the first terminal and the second terminal are used for sensing. The sensing terminal is a terminal participating in a sensing service, for example, the sensing terminal sends a signal, and a base station obtains a sensing measurement quantity by receiving the signal; and for another example, the base station sends a signal, and the sensing terminal obtains the sensing measurement quantity by receiving the signal.

That the sensing terminal is determined to be changed may be that the first device determines to change the sensing terminal, and based on association information or service information of the terminal, the sensing terminal may be determined to be changed.

The first device may be a network side device, such as a radio access network device or a core network device, and in some implementations, the first device may also be a terminal, such as the terminal currently performing the sensing operation.

The selecting the first terminal may be selecting the first terminal from one or more candidate terminals.

In addition, the first terminal may be one or more terminals.

The changing the sensing terminal may include changing the sensing terminal caused by at least one of the following reasons:
moving of the sensing target, leading to switch of a receive end and a transmit end of a sensing signal participating in a sensing process;
moving of the receive end of the sensing signal, leading to switch of the receive end and the transmit end of the sensing signal; or
moving of the transmit end of the sensing signal, leading to switch of the receive end and the transmit end of the sensing signal.

Step 302: The first device sends a notification message to the first terminal, where the notification message is used to notify the first terminal of performing a sensing operation.

Through the foregoing steps, the first terminal may perform the sensing operation, where the sensing operation may be an uplink sensing operation, for example, the terminal sends a signal, or the sensing operation may be a downlink sensing operation, for example, the terminal measures a downlink signal to obtain a sensing measurement quantity, and the sensing operation may be self-transmit self-receive sensing of the terminal.

A signal corresponding to the sensing operation may include at least one of the following:
a preamble sequence, a sensing signal, a reference signal, a synchronization signal, or a data signal.

The sensing signal may be a dedicated sensing signal, or a signal defined in a multiplexed communication system may be used as the sensing signal, for example, a communication signal defined in a protocol is used as the sensing signal.

It should be noted that in sensing measurement, one or more devices may send signals to one device, one or more devices may send signals to a plurality of devices, one device may receive a sensing measurement quantity sent by a plurality of devices, or the like. In this embodiment of this application, the first device, the first terminal, and the second terminal may refer to one or more devices.

In this embodiment of this application, the sensing operation corresponds to a sensing target (also referred to as a sensing object), and the sensing target may be any sensing target supported in the sensing measurement technology, for example, a static or dynamic target such as a human, a vehicle, a device, a building, an animal, a plant, or the like, which is not limited.

In this embodiment of this application, through the foregoing steps, the first terminal may be notified of performing the sensing operation, to change the sensing terminal, thereby improving flexibility of sensing measurement and maintaining continuity of the sensing service.

In an implementation, that a first device selects a first terminal in a case that a sensing terminal is determined to be changed includes:
selecting the first terminal in a case that the first device determines, based on association information of a second terminal, to change the sensing terminal, where
change of the sensing terminal includes changing the second terminal to the first terminal.

The second terminal is a terminal that has performed the sensing operation, and the second terminal may be one or more terminals.

The changing the second terminal to the first terminal may be changing sensing by the second terminal to sensing by the first terminal; or the second terminal is a partially sensing terminal, and the changing the second terminal to the first terminal refers to changing the partially sensing terminal. For example, sensing terminals include the second terminal and a third terminal, and in this way, the second terminal is changed to the first terminal, so that sensing by the second terminal and the third terminal is changed to sensing by the first terminal and the third terminal.

It should be noted that the changing the second terminal to the first terminal may be that the first terminal performs the sensing operation when the second terminal stops the sensing operation, or the first terminal also performs the sensing operation when the second terminal performs the sensing operation, that is, a time when the first terminal performs the sensing operation and a time when the second terminal performs the sensing operation partially overlap, but the second terminal may stop the sensing operation within a specific time after the first terminal performs the sensing operation, where the time may be configured according to an actual requirement.

The determining, based on association information of a second terminal, to change the sensing terminal may be determining, based on the association information of the second terminal, that the second terminal is not suitable or unable to perform the sensing operation, and then the sensing terminal is determined to be changed.

In this implementation, the second terminal may be changed to the first terminal for the sensing operation, to ensure continuity of the sensing service.

It should be noted that in this embodiment of this application, it is not limited to determining to change the sensing terminal based on the association information of the second terminal. For example, in some embodiments, based on a requirement of a sensing service, the sensing terminal may also be determined to be changed. If a sensing measurement quantity required by the sensing service or accuracy requirement of the measurement result becomes higher, a sensing terminal is added for sensing operation.

In some embodiments, the association information of the second terminal includes at least one of the following:
a measurement result that is of a first signal sent by the first device and that is reported by the second terminal;
sensing terminal change information reported by the second terminal;
a measurement result that is of a second signal sent by the second terminal and that is obtained by the first device; or
a measurement result of the second signal reported by the second terminal, where
the first signal includes at least one of a sensing signal, a reference signal, a synchronization signal, or a data signal; and the second signal includes at least one of a sensing signal, a reference signal, or a data signal.

In this embodiment of this application, the signal sent by the first device to a terminal is referred to as the first signal, and a signal sent by the terminal is referred to as the second signal, where the second signal includes a signal sent by the terminal to the first device, or a signal sent and received by the terminal.

The measurement result of the second signal reported by the second terminal may be a measurement result obtained by the second terminal by measuring a signal sent by the second terminal, or a measurement result obtained by the second terminal by measuring a signal sent by another terminal.

The sensing terminal change information may be used to represent information that the sensing terminal needs to change. In some implementations, the sensing terminal change information reported by the second terminal may be reported by the second terminal based on at least one of the following:
power of the second terminal;
a service of the second terminal;
a physical state of the second terminal;
an orientation of the second terminal; or
a motion direction of the second terminal.

For example, if power of the second terminal is lower than a threshold, and the sensing terminal change information is reported, power of the terminal may be saved and interruption of the sensing service may be avoided by changing the sensing terminal. For another example, if the second terminal has a more important service burst, such as an Ultra-Reliable and Low Latency Communications (URLLC) service, interruption of the sensing service may be avoided by changing the sensing terminal. For still another example, if the physical state of the second terminal is no longer suitable for performing the sensing operation, interruption of the sensing service may be avoided by changing the sensing terminal. For yet another example, if the orientation of the second terminal cannot sense the sensing target, interruption of the sensing service may be avoided by changing the sensing terminal. For still yet another example, if the motion direction of the second terminal indicates that the terminal cannot sensing the sensing target after motion, interruption of the sensing service may be avoided by changing the sensing terminal.

In this implementation, the sensing terminal change information is reported based on at least one of the foregoing, so that interruption of the sensing service may be avoided, and continuity of the sensing service may be ensured.

The measurement result that is of the first signal sent by the second terminal and that is obtained by the first device may be a measurement result obtained by the first device by measuring the first signal sent by the second terminal.

In this implementation, based on at least one piece of the foregoing information, the sensing terminal is determined to be changed, to realize multi-dimensional determining on whether the sensing terminal needs to be changed, and further improve flexibility of sensing measurement.

In some embodiments, the method further includes:
sending, by the first device, first measurement configuration information to the second terminal, where
the first measurement configuration information includes at least one of the following:
a measurement object, where the measurement object includes at least one of the following: configuration information of the first signal, for example, the measurement object is a specific type of reference signal, and a time domain resource, a frequency domain resource, and a subcarrier spacing of the reference signal, and the like;
measurement report configuration information, where the measurement report configuration information includes at least one of the following: a reporting manner, a type of a reference signal used for measurement, or measurement report content; the reporting manner includes periodic reporting or reporting triggered by a measurement event; and the measurement report content includes at least one of the following: a communication-related indicator, a sensing-related indicator, a sensing measurement quantity, a sensing result, or a performance indicator of a target parameter; or
a measurement identifier, where one measurement identifier is used to associate at least one measurement object and at least one piece of the measurement report configuration information; and
in a case that the reporting manner includes reporting triggered by a measurement event, the first measurement configuration information further includes a measurement event.

It should be noted that in some implementations, at least one of the measurement object, the measurement report configuration information, the measurement identifier, and the measurement event may also be pre-configured or defined by a protocol, that is, in these implementations, at least one of the measurement object, the measurement report configuration information, the measurement identifier, and the measurement event may be configured for the second terminal without using the first device.

The configuration information of the first signal may include parameter information, resource information, and the like of the first signal, for example, time-frequency resource information, a subcarrier spacing, a signal type such as a synchronization signal or a specific type of reference signal or a specific type of sensing signal, and the like of the signal. For details, refer to corresponding descriptions of the parameter information and the resource information of the sensing signal described above. Details are not described herein again.

The sensing-related indicator may also be referred to as a sensing performance evaluation indicator. In some implementations, the sensing-related indicator includes at least one of the following:
a sensing SNR, a sensing Signal to Interference plus Noise Ratio (SINR), statistics on a plurality of measurement results of a sensing measurement quantity, deviation information between a predicted value and an actual measurement value of a sensing measurement quantity, deviation information between a predicted value and an actual measurement value of a measurement result, similar information of a signal sequence, or an echo signal power.

The sensing SNR may be a ratio of an energy of a sensing object or a sensing signal reflected in a sensing region to a noise signal energy in an environment and a device; and
the sensing SINR may be a ratio of an energy of a sensing object or a sensing signal reflected in a sensing region to a sum of an interference signal energy and a noise signal energy in an environment and a device.

The method for obtaining the sensing SNR and the sensing SINR may include at least one of the following manners.

Manner 1: Perform Constant False Alarm Rate (CFAR) detection based on a delay one-dimensional diagram obtained through fast time-dimension FFT processing of an echo signal, use a sample point with a maximum amplitude of CFAR crossing a threshold as a target sample point, use the amplitude as a target signal amplitude, use all sample points other than a sample point that is ±F sample points from a target sample point location in the one-dimensional diagram as interference/noise sample points, count an average interference/amplitude thereof as an interference/noise signal amplitude, and as shown in FIG. 4, finally, calculate the SNR/SINR with the target signal amplitude and the interference/noise signal amplitude, where F is a constant;

Manner 2: Perform CFAR detection based on a Doppler one-dimensional diagram obtained through slow time-dimension FFT processing of an echo signal, use a sample point with a maximum amplitude of CFAR crossing a threshold as a target sample point, use the amplitude as a target signal amplitude, use all sample points other than a sample point that is ±η sample points from a target sample point location in the one-dimensional diagram as interference/noise sample points, count an average amplitude thereof as an interference/noise signal amplitude, and finally, calculate the SNR/SINR with the target signal amplitude and the interference/noise signal amplitude, where η is a constant;

Manner 3: Perform CFAR detection based on a delay-Doppler two-dimensional diagram obtained through 2D-FFT processing of an echo signal, use a sample point with a maximum amplitude of CFAR crossing a threshold as a target sample point, use the amplitude as a target signal amplitude, use all sample points other than a sample point that is ±ε (fast time-dimension) and ±η (slow time-dimension) sample points from the target sample point in the two-dimensional diagram as interference/noise sample points, count an average amplitude thereof as an interference/noise signal amplitude, and finally, calculate the SNR/SINR with the target signal amplitude and the interference/noise signal amplitude;

Manner 4: Perform CFAR detection based on a delay-Doppler-angle three-dimensional diagram obtained through 3D-FFT processing of an echo signal, use a sample point with a maximum amplitude of CFAR crossing a threshold as a target sample point, use the amplitude as a target signal amplitude, use all sample points other than a sample point that is ±ε (fast time-dimension), ±η (slow time-dimension), and ±δ (angle-dimension) sample points from the target sample point in the three-dimensional diagram as interference/noise sample points, count an average amplitude thereof as an interference/noise signal amplitude, and finally, calculate the SNR/SINR with the target signal amplitude and the interference/noise signal amplitude, where δ is a constant; or

Manner 5: In addition to using the sample point with a maximum amplitude of CFAR crossing a threshold as the target sample point, the method for determining the target signal amplitude may also be using an average value of the sample point with a maximum amplitude of CFAR crossing a threshold and nearest several sample points crossing a threshold as the target signal amplitude.

In addition, the method for determining the interference/noise sample point may also be further screening based on the determined interference/noise sample point. The screening method is as follows: for the delay one-dimensional diagram, several sample points near a delay of 0 are removed, and remaining interference/noise sample points are used as noise sample points; or for the Doppler one-dimensional diagram, several sample points near Doppler of 0 are removed, and remaining interference/noise sample points are used as interference/noise sample points; or for the delay-Doppler two-dimensional diagram, several interference/noise sample points that are in a strip range including all of a Doppler range and that are near a delay of 0 are removed, and remaining noise sample points are used as interference/noise sample points; or for the delay-Doppler-angle three-dimensional diagram, several interference/noise sample points that are in a slice-like range including all of a Doppler range and all of an angle range and that are near a delay of 0 are removed, and remaining interference/noise sample points are used as interference/noise sample points.

The statistics on a plurality of measurement results of a sensing measurement quantity may be a statistical average, a standard deviation, or a variance of a plurality of measurement results of a same sensing measurement quantity.

The deviation information between a predicted value and an actual measurement value of a sensing measurement quantity may include a deviation between the predicted value and the actual measurement value of the sensing measurement quantity, and a statistical average, a standard deviation, or a variance of the deviation.

The deviation information between a predicted value and an actual measurement value of a measurement result may include a deviation between the predicted value and the actual measurement value of the sensing result, and a statistical average, a standard deviation, or a variance of the deviation.

Similar information of the signal sequence may be an indicator defined in a multiplexing protocol, for example, at least one of the following:
a sum of Euclidean distances between sample points of two sequences before and after;
a regular path distance in Dynamic Time Warping (DTW); or
other indicators that can reflect similarity of two sequences, including but not limited to: a Longest Common Subsequence (LCSS), an Edit Distance on Real Sequences (EDR), an Edit Distance with Real Penalty (ERP), a Hausdorff Distance, a Fréchet distance, a One Way Distance (OWD), a Locality In-between Polylines (LIP), and the like.

The echo signal power may be an echo signal power of the first signal.

In some implementations, the echo signal power may be obtained in at least one of the following manners:

Manner 1: Perform Constant False Alarm Rate (CFAR) detection based on a delay one-dimensional diagram obtained through fast time-dimension FFT processing of an echo signal, use a sample point with a maximum amplitude of CFAR crossing a threshold as a target sample point, and use the amplitude as a target signal amplitude to calculate the echo signal power, where details may be shown in FIG. 4;

Manner 2: Perform CFAR detection based on a Doppler one-dimensional diagram obtained through slow time-dimension FFT processing of an echo signal, use a sample point with a maximum amplitude of CFAR crossing a threshold as a target sample point, and use the amplitude as a target signal amplitude to calculate the echo signal power, as shown in FIG. 4;

Manner 3: Perform CFAR detection based on a delay-Doppler two-dimensional diagram obtained through 2D-FFT processing of an echo signal, use a sample point with a maximum amplitude of CFAR crossing a threshold as a target sample point, and use the amplitude as a target signal amplitude to calculate the echo signal power;

Manner 4: Perform CFAR detection based on a delay-Doppler-angle three-dimensional diagram obtained through 3D-FFT processing of an echo signal, use a sample point with a maximum amplitude of CFAR crossing a threshold as a target sample point, and use the amplitude as a target signal amplitude to calculate the echo signal power; or

Manner 5: In addition to using the sample point with a maximum amplitude of CFAR crossing a threshold as the target sample point, the method for determining the target signal amplitude may also be using an average value of the sample point with a maximum amplitude of CFAR crossing a threshold and nearest several sample points crossing a threshold as the target signal amplitude to calculate the echo signal power.

The measurement event in the reporting triggered by a measurement event may be a measurement event indicating that the sensing terminal change is satisfied, for example, the sensing performance indicator satisfies a change condition of the sensing terminal, or the sensing measurement quantity satisfies a change condition of the sensing terminal, or the sensing result satisfies a change condition of the sensing terminal, or a parameter of the sensing signal satisfies a change condition of the sensing terminal, or a state or a location of the second terminal satisfies a change condition of the sensing terminal.

In some implementations, the measurement event may include at least one of the following:
at least one sensing-related indicator satisfies a first preset condition;
at least one sensing measurement quantity satisfies a second preset condition;
at least one sensing result satisfies a third preset condition;
at least one parameter of a sensing signal satisfies a fourth preset condition;
a state of a sensing target changes;
a location of the second terminal changes; or
at least one communication-related indicator of a non-serving cell and/or serving cell of the second terminal satisfies a fifth preset condition.

That the at least one sensing-related indicator satisfies a first preset condition may be that a sensing-related indicator that is of a sensing signal sent by a base station and that is measured by the second terminal is lower than a preset threshold within a preset time period, or a quantity of times of lowering than the preset threshold within the preset time period reaches a preset quantity of times.

That the at least one sensing measurement quantity satisfies a second preset condition may be that a sensing measurement quantity that is of a sensing signal sent by a base station and that is measured by the second terminal is lower than a preset threshold within a preset time period, or a quantity of times of lowering than the preset threshold within the preset time period reaches a preset quantity of times.

That the at least one sensing result satisfies a third preset condition may be that at least one sensing result does not satisfy the preset condition within a preset time period, for example, a downlink sensing result does not satisfy the preset condition within the preset time period.

That the at least one parameter of a sensing signal satisfies a fourth preset condition may be that parameter information of the at least one sensing signal does not satisfy a minimum configuration requirement of sensing QoS.

That the state of a sensing target changes may be that the sensing target changes in location, speed, and the like, and the change causes that the sensing terminal needs to be changed.

That the location of the second terminal changes may be that location change of the second terminal causes the second terminal to be unable to continue the sensing operation, for example, the second terminal moves out from a coverage area of the base station.

That the at least one communication-related indicator of a non-serving cell and/or serving cell of the second terminal satisfies a fifth preset condition may be that the communication-related indicator of the non-serving cell satisfies a condition of cell handover or entering the cell, and the communication-related indicator of the serving cell satisfies a condition of cell handover or leaving the cell.

For example, that the at least one communication-related indicator of a non-serving cell and/or serving cell of the second terminal satisfies a fifth preset condition may be shown in the following table.

| | | Conditions for |
|---|---|---|
| Event | Definition | entering and leaving |
| Event A1 | Serving cell | Conditions for entering: |
| | quality is higher | Ms − Hys > Thresh |
| | than a threshold | Conditions for leaving: |
| | | Ms + Hys < Thresh |
| Event A2 | Serving cell | Conditions for entering: |
| | quality is lower | Ms + Hys < Thresh |
| | than a threshold | Conditions for leaving: |
| | | Ms − Hys > Thresh |
| Event I1 | Interference | Conditions for entering: |
| | quality is higher | Mi − Hys > Thresh |
| | than a threshold | Conditions for leaving: |
| | | Mi + Hys < Thresh |

Ms represents a measurement result, Mi represents a measurement result, Hys is a hysteresis parameter, and Thresh is a threshold value.

In some implementations, a time to trigger parameter is configured for each event, and a next step is triggered only when L3 filtering signal quality of one or more candidate cells in the time to trigger satisfies conditions for entering of the event.

The serving cell quality includes at least one of Reference Signal Received Power (RSRP), SINR, Reference Signal Received Quality (RSRQ), Received Signal Strength Indication (RSSI), or the like.

For the measurement event, a satisfied measurement event is determined in at least one of the following cases, the second terminal reports the measurement event to the first device, and the first device determines to change the sensing terminal:
an RSRP of the first signal is lower than a first threshold (for example, −100 dBm);
a sensing SNR of the first signal is lower than a second threshold (for example, 5 dB);
an expected sensing object cannot be found in a delay Doppler spectrum obtained based on the first signal; and
an amplitude of a delay Doppler spectrum related to a sensing object in the delay Doppler spectrum obtained based on the first signal does not reach an expected threshold.

In an implementation, the measurement result of the second signal is used to represent at least one of the following:
a communication-related indicator of the second signal received by the second terminal;
a sensing-related indicator of the second signal received by the second terminal;
a sensing measurement quantity obtained by the second terminal by using the received second signal;
a sensing result obtained by the second terminal by using the received second signal; or
a performance indicator of a target parameter obtained by the second terminal by using the received second signal, where
the second signal is a signal sent and received by the second terminal.

The communication-related indicator may include at least one of the following: RSRP, SINR, RSRQ, or RSSI.

For example, if an RSRP of the second signal is lower than the first threshold (for example, −100 dBm), the sensing terminal is determined to be changed.

In this implementation, the first device determines to change the sensing terminal based on at least one of the foregoing, for example, the sensing terminal is determined to be changed in at least one of the following cases:
the communication-related indicator of the second signal received by the second terminal is lower than the first threshold;
the sensing-related indicator of the second signal received by the second terminal is lower than the second threshold;
the sensing measurement quantity obtained by the second terminal by using the received second signal does not satisfy a first preset requirement;
the sensing result obtained by the second terminal by using the received second signal does not satisfy a second preset requirement; or
the performance indicator of the target parameter obtained by the second terminal by using the received second signal does not satisfy a third preset requirement.

The first threshold, the second threshold, the first preset requirement, the second preset requirement, and the third preset requirement are defined by a protocol or pre-configured, which may be determined based on an actual sensing service. For example, that the sensing measurement quantity does not satisfy the first preset requirement may be that the second terminal obtains sensing measurement quantities by using received one or more first signals, but a measurement quantity related to a sensing object cannot be obtained by using these sensing measurement quantities. For another example, that the sensing result does not satisfy the second preset requirement may be that the second terminal obtains sensing results by using received one or more first signals, but these sensing results cannot express at least one information of the following: a shape, a spatial location, an orientation, a displacement, a moving speed, an acceleration, and the like of the sensing object.

In some implementations, the target parameter may include at least one of the following:
a target parameter in a polar coordinate system and a target parameter in an inertial system; or
the performance indicator of the target parameter includes at least one of the following:
a variance of a residual of the target parameter, a standard deviation of a residual of the target parameter, a covariance of a prediction error of the target parameter, or a covariance of a state estimation error of the target parameter.

The target parameter in the polar coordinate system may be a target parameter in a polar coordinate system directly obtained by radar detection, and may include at least one of the following: a radial distance of a sensing object relative to a radar, a radial speed of the sensing object relative to the radar, or an angle of the sensing object relative to the radar, where the angle includes, for example, at least one of a direction angle or a pitch angle.

The target parameter in the inertial system may be a target parameter in the inertial system after coordinate changes, and may include at least one of the following:
a coordinate of the sensing object in the inertial system, including, for example, at least one of an x-axis coordinate, a y-axis coordinate, or a z-axis coordinate; or
a speed of the sensing object in the inertial system, including, for example, at least one of an x-direction speed, a y-direction speed, or a z-direction speed.

The performance indicator of the target parameter may be obtained through data processing based on the target parameter, for example, the residual of the target parameter may be a difference between a value of the target parameter measured by a second sensing frame and a value of the corresponding target parameter of the second sensing frame predicted by a first sensing frame, and the variance or the standard deviation of the residual may be calculated in a sliding window manner. For another example, the covariance of the prediction error of the target parameter may be a covariance of a prediction error obtained during an execution process of a prediction algorithm, and the covariance of the state estimation error of the target parameter may be a covariance of an estimation error obtained during the execution process of the prediction algorithm.

In this implementation, in a case that the measurement result represents at least one of the indicator, the sensing measurement quantity, the sensing result, and the performance indicator of the target parameter, the first device determines, based on these measurement results, whether a corresponding threshold or requirement is satisfied, to determine whether to change the sensing terminal; and in a case that the measurement result represents a relationship between at least one of the indicator, the sensing measurement quantity, the sensing result, and the performance indicator of the target parameter and a corresponding threshold or requirement, the first device directly determines, based on the measurement result, whether to change the sensing terminal.

In an implementation, the measurement result that is of the second signal sent by the second terminal and that is obtained by the first device is used to represent at least one of the following:
a communication-related indicator of the second signal received by the first device;
a sensing-related indicator of the second signal received by the first device;
a sensing measurement quantity obtained by the first device by using the received second signal;
a sensing result obtained by the first device by using the received second signal; or
a performance indicator of a target parameter obtained by the first device by using the received second signal, where
the second signal is a signal sent by the second terminal.

For the indicator, the sensing measurement quantity, and the sensing result, refer to the corresponding description of the foregoing implementation. Details are not described herein again.

In this implementation, the first device determines, based on the measurement result, whether a corresponding threshold or requirement is satisfied, to determine whether to change the sensing terminal.

In an implementation, the selecting the first terminal includes:
selecting, based on association information of a candidate terminal, the first terminal from the candidate terminal, where
the association information of the candidate terminal includes at least one of the following:
terminal information of the candidate terminal;
measurement information of a first signal received by the candidate terminal; or
measurement information of a second signal sent by the candidate terminal.

In some implementations, the terminal information may include at least one of the following:
location information, capability information, sensing subscription information, or state information.

For example, a terminal with terminal information matching the sensing service best is selected from candidate terminals as the first terminal.

In some implementations, the measurement information may include:
a communication-related indicator, a sensing-related indicator, a sensing measurement quantity, a sensing result, and a performance indicator of a target parameter.

The measurement information of the first signal received by the candidate terminal may be that the candidate terminal receives the first signal and reports the measurement information of the first signal, for example, the first device indicates one or more candidate terminals to receive the first signal and reports at least one of a communication-related indicator, a sensing-related indicator, a sensing measurement quantity, a sensing result, and a performance indicator of a target parameter of the first signal, and the first device determines, based on whether these indicators and/or results satisfy corresponding thresholds or requirements respectively, the first terminal, namely, a terminal participating in sensing. A terminal with at least one of the following may be determined as the first terminal:
a communication-related indicator higher than a fifth threshold, a sensing-related indicator higher than a sixth threshold, a sensing measurement quantity satisfying a seventh preset requirement, a sensing result satisfying an eighth requirement, or a performance indicator of a target parameter satisfying a ninth requirement.

It should be noted that these thresholds and requirements may be flexibly set or agreed by a protocol according to an actual situation.

The measurement information of the second signal sent by the candidate terminal may be that the first device notifies one or more candidate terminals of sending a second signal, and receives a second signal sent by the first device, to obtain at least one of a communication-related indicator, a sensing-related indicator, a sensing measurement quantity, a sensing result, or a performance indicator of a target parameter of the second signal; and the first device determines, based on whether these indicators and/or results satisfy corresponding thresholds or requirements respectively, the first terminal, namely, a terminal participating in sensing. A terminal with at least one of the following may be determined as the first terminal:
a communication-related indicator higher than a seventh threshold, a sensing-related indicator higher than an eighth threshold, a sensing measurement quantity satisfying a tenth preset requirement, a sensing result satisfying an eleventh requirement, or a performance indicator of a target parameter satisfying a twelfth requirement.

It should be noted that these thresholds and requirements may be flexibly set or agreed by a protocol according to an actual situation.

In this implementation, based on the association information of the candidate terminal, a first terminal that satisfies a requirement of the sensing service may be selected to improve performance of the sensing service.

In an implementation, the notification message includes at least one of the following: configuration information of the second signal;
a sensing measurement quantity;
a sensing context; or
a threshold, where
the configuration information of the second signal includes at least one of the following: parameter information or resource information;
the sensing context includes at least one of the following: a sensing measurement quantity associated with the second terminal or a sensing result associated with the second terminal; or
the threshold is a discrimination threshold for sensing.

A sensing target corresponding to the sensing measurement quantity associated with the second terminal and the sensing result associated with the second terminal and a sensing target corresponding to the sensing operation performed by the first terminal are the same sensing target.

In this implementation, at least one of the foregoing is included in the notification message, so that the first terminal may directly perform a corresponding sensing operation based on the at least one of the foregoing, to improve sensing performance of the terminal.

It should be noted that at least one of the foregoing may be pre-configured or defined by a protocol.

In an implementation, the method further includes at least one of the following:
sending, by the first device, a notification message for stopping the sensing operation to the second terminal;
obtaining, by the first device, a sensing measurement quantity for the sensing target based on a sensing measurement quantity associated with the second terminal and a sensing measurement quantity associated with the first terminal; or
obtaining, by the first device, a sensing result for the sensing target based on a sensing result associated with the second terminal and a sensing result associated with the first terminal.

The notification message for stopping the sensing operation may be used to notify the second terminal of exiting a sensing procedure, to reduce power consumption of the second terminal.

The obtaining a sensing measurement quantity for the sensing target based on a sensing measurement quantity associated with the second terminal and a sensing measurement quantity associated with the first terminal may be combining sensing measurement quantities of a plurality of terminals, which can not only improve service efficiency of the sensing service, but also reduce power consumption of the first terminal because the first terminal needs to perform only a part of the sensing operation in a case of combination.

The obtaining a sensing result for the sensing target based on a sensing result associated with the second terminal and a sensing result associated with the first terminal may be combining sensing results of a plurality of terminals, which can not only improve service efficiency of the sensing service, but also reduce power consumption of the first terminal because the first terminal needs to perform only a part of the sensing operation in a case of combination.

For example, moments at which the first terminal and the second terminal send at least one of a preamble sequence, a reference signal, or a sensing signal coincide for a period of time, and in this case, the first device may combine measurement quantities and/or sensing results corresponding to signals sent by the first terminal and the second terminal.

In an implementation, the sensing operation includes one of the following:
receiving a first signal and feeding back a sensing measurement quantity related to the first signal;
sending a second signal; or
sending a second signal, receiving the second signal, and feeding back a sensing measurement quantity related to the second signal.

The receiving a first signal and feeding back a sensing measurement quantity related to the first signal may be understood as performing a downlink sensing operation, where the first signal includes at least one of a sensing signal, a reference signal, a synchronization signal, or a data signal.

The sending a second signal may be understood as performing an uplink sensing operation, where the second signal includes at least one of a sensing signal, a reference signal, or a data signal.

The sending a second signal, receiving the second signal, and feeding back a sensing measurement quantity related to the second signal may be understood as performing self-transmit self-receive sensing of the terminal.

In this implementation, changing of the sensing terminal in uplink sensing, downlink sensing, and self-transmit self-receive sensing of the terminal may be supported, and the first device remains unchanged in these procedures.

In an implementation, the notification message is further used to indicate the first terminal to enter a connected state in a case that the first terminal is in an idle state or an inactive state.

In this implementation, in a case that the first terminal is in the idle state or the inactive state, the first terminal needs to enter the connected state before performing a sensing operation.

In this implementation, because the notification message is further used to indicate the first terminal to enter the connected state, this avoids introduction of an additional message, to avoid transmission overheads.

In the embodiments of this application, the first device selects a first terminal in a case that a sensing terminal is determined to be changed; and the first device sends a notification message to the first terminal, where the notification message is used to notify the first terminal of performing a sensing operation. In this way, the first terminal is notified of performing the sensing operation, to change the sensing terminal, thereby improving flexibility of sensing measurement and maintaining continuity of the sensing service.

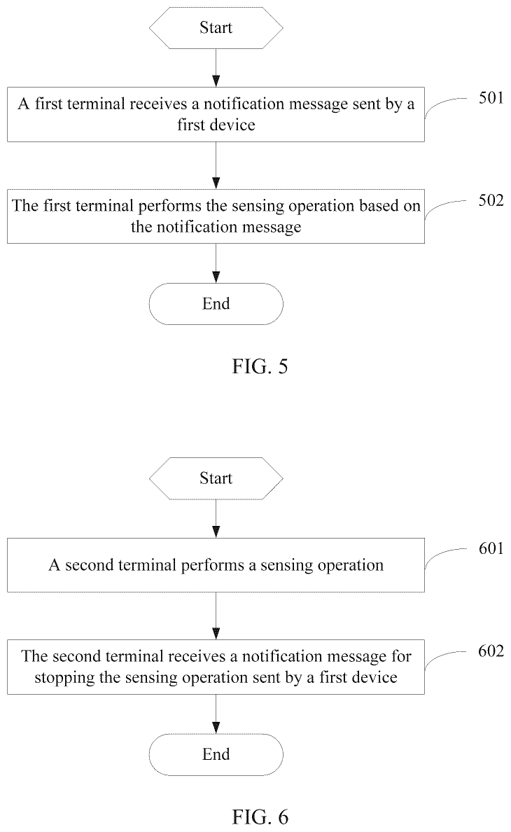

Referring to FIG. 5, FIG. 5 is a flowchart of another sensing measurement method according to an embodiment of this application. As shown in FIG. 5, the method includes the following steps.

Step 501: A first terminal receives a notification message sent by a first device, where the notification message is used to notify the first terminal of performing a sensing operation.

Step 502: The first terminal performs the sensing operation based on the notification message.

In some embodiments, the method further includes:
sending, by the first terminal, terminal information of the first terminal to the first device;
sending, by the first terminal, measurement information to the first device, where the measurement information is information obtained by the first terminal by measuring a received first signal; and
sending, by the first terminal, a second signal to the first device.

In some embodiments, the terminal information includes at least one of the following:
location information, capability information, sensing subscription information, or state information;
and/or
the measurement information includes at least one of the following:
a communication-related indicator, a sensing-related indicator, a sensing measurement quantity, a sensing result, or a performance indicator of a target parameter.

In some embodiments, in a case that the first terminal is in an idle state or an inactive state, the first terminal enters a connected state to receive the first signal or send the second signal; or
the first terminal receives the first signal or sends the second signal in the idle state.

In some embodiments, the notification message includes at least one of the following: configuration information of the second signal;
a sensing measurement quantity;
a sensing context; or
a threshold, where
the configuration information of the second signal includes at least one of the following: parameter information or resource information;
the sensing context includes at least one of the following: a sensing measurement quantity associated with a second terminal or a sensing result associated with the second terminal, where the second terminal is a sensing terminal that performs a sensing operation before the first terminal performs the sensing operation; or
the threshold is a discrimination threshold for sensing.

In some embodiments, the sensing operation includes one of the following:
receiving a first signal and feeding back a sensing measurement quantity related to the first signal;
sending a second signal; or
sending a second signal, receiving the second signal, and feeding back a sensing measurement quantity related to the second signal.

It should be noted that this embodiment is used as an implementation of the first terminal corresponding to the embodiment shown in FIG. 3. For an implementation of this embodiment, refer to the related descriptions of the embodiment shown in FIG. 3. To avoid repeated descriptions, details are not described again in this embodiment.

Referring to FIG. 6, FIG. 6 is a flowchart of still another sensing measurement method according to an embodiment of this application. As shown in FIG. 6, the method includes the following steps.

Step 601: A second terminal performs a sensing operation.

Step 602: The second terminal receives a notification message for stopping the sensing operation sent by a first device.

In some embodiments, the notification message is sent based on association information of the second terminal.

In some embodiments, the association information of the second terminal includes at least one of the following:
a measurement result that is of a first signal sent by the first device and that is reported by the second terminal;
sensing terminal change information reported by the second terminal;
a measurement result that is of a second signal sent by the second terminal and that is obtained by the first device; or
a measurement result of the second signal reported by the second terminal, where
the first signal includes at least one of a sensing signal, a reference signal, a synchronization signal, or a data signal; and the second signal includes at least one of a sensing signal, a reference signal, or a data signal.

In some embodiments, the method further includes:
obtaining, by the second terminal, first measurement configuration information sent by the first device, where
the first measurement configuration information includes at least one of the following:
a measurement object, where the measurement object includes configuration information of the first signal;
measurement report configuration information, where the measurement report configuration information includes at least one of the following: a reporting manner, a type of a reference signal used for measurement, or measurement report content; the reporting manner includes periodic reporting or reporting triggered by a measurement event; and the measurement report content includes at least one of the following: a communication-related indicator, a sensing-related indicator, a sensing measurement quantity, a sensing result, or a performance indicator of a target parameter; or
a measurement identifier, where one measurement identifier is used to associate at least one measurement object and at least one piece of the measurement report configuration information; and
in a case that the reporting manner includes reporting triggered by a measurement event, the first measurement configuration information further includes a measurement event.

In some embodiments, the measurement configuration information includes at least one of the following:
the measurement event includes at least one of the following:
at least one sensing-related indicator satisfies a first preset condition;
at least one sensing measurement quantity satisfies a second preset condition;
at least one sensing result satisfies a third preset condition;
at least one parameter of a sensing signal satisfies a fourth preset condition;
a state of a sensing target changes;
a location of the second terminal changes; or
at least one communication-related indicator of a non-serving cell and/or serving cell of the second terminal satisfies a fifth preset condition.

In some embodiments, the sensing-related indicator includes at least one of the following:
a sensing signal to noise ratio (SNR), a sensing signal to interference plus noise ratio (SINR), statistics on a plurality of measurement results of a sensing measurement quantity, deviation information between a predicted value and an actual measurement value of a sensing measurement quantity, deviation information between a predicted value and an actual measurement value of a measurement result, similar information of a signal sequence, or an echo signal power.

In some embodiments, the measurement result of the second signal is used to represent at least one of the following:
a communication-related indicator of the second signal received by the second terminal;
a sensing-related indicator of the second signal received by the second terminal;
a sensing measurement quantity obtained by the second terminal by using the received second signal;
a sensing result obtained by the second terminal by using the received second signal; or
a performance indicator of a target parameter obtained by the second terminal by using the received second signal, where
the second signal is a signal sent and received by the second terminal.

In some embodiments, the target parameter includes at least one of the following:
a target parameter in a polar coordinate system and a target parameter in an inertial system; or
the performance indicator of the target parameter includes at least one of the following:
a variance of a residual of the target parameter, a standard deviation of a residual of the target parameter, a covariance of a prediction error of the target parameter, or a covariance of a state estimation error of the target parameter.

In some embodiments, the sensing terminal change information reported by the second terminal is reported by the second terminal based on at least one of the following:
power of the second terminal;
a service of the second terminal;
a physical state of the second terminal;
an orientation of the second terminal; or
a motion direction of the second terminal.

It should be noted that this embodiment is used as an implementation of the second terminal corresponding to the embodiment shown in FIG. 3. For an implementation of this embodiment, refer to the related descriptions of the embodiment shown in FIG. 3. To avoid repeated descriptions, details are not described again in this embodiment.

The sensing measurement method provided in the embodiments of this application is described as examples below by using a plurality of embodiments.

### Embodiment 1

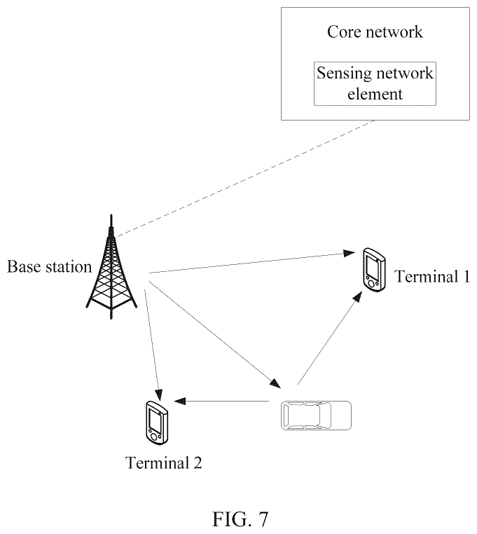

This embodiment uses a downlink sensing scenario shown in FIG. 7 as an example for description. A base station is unchanged in this scenario, and sensing by terminal 1 is switched to sensing by terminal 2. In this scenario, as shown in FIG. 7, when terminal 1 is a sensing terminal, the base station sends downlink signals to terminal 1, and terminal 1 receives two parts of the downlink signals. One part of the signals reaches terminal 1 from the base station through a line-of-sight path, and the other part of the signals is: the downlink signal sent by the base station reaches terminal 1 after being transmitted by a sensing target/object (such as a vehicle). When the sensing terminal is switched from terminal 1 to terminal 2, the base station sends downlink signals to terminal 2, and terminal 2 receives two parts of the downlink signals. One part of the signals reaches terminal 2 from the base station through a line-of-sight path, and the other part of the signals is: the downlink signal sent by the base station reaches terminal 2 after being transmitted by a sensing target/object (a vehicle). Sensing terminal switching may include the following:

Step 1: If at least one of the following three conditions is met, Step 2 is performed:

Condition 1: a base station or a core network device sends measurement configuration information to terminal 1 participating in sensing, terminal 1 performs measurement and reports a measurement result to the base station, and the base station determines, based on the measurement result, that Step 2 needs to be performed; or

Condition 2: a base station or a core network device sends measurement event configuration information to terminal 1 participating in sensing, and if terminal 1 finds a satisfied measurement event during measurement, terminal 1 reports the measurement event to the base station; or

Condition 3: terminal 1 determines whether a sensing procedure needs to be switched to another UE, and reports it to a network.

For Condition 1, the measurement configuration information may include at least one of the following:
a measurement object: for example, parameter information and resource information of one or more first signals that are of a base station and that need to be measured (explanation 2);
a measurement report (MR) configuration: the configuration includes: a reporting principle, which may be periodic reporting or the like; a type of reference signal for measurement or the like; a measurement report format, such as a maximum quantity of reported cells and a quantity of beams;
a measurement result/reported content: for example, a sensing performance evaluation indicator, a sensing measurement quantity, a sensing result, a state of a sensing target, a location of a terminal participating in sensing, and the like; or
a measurement ID: the measurement ID is used to associate a measurement object with a measurement report configuration.

The method that the base station determines, based on the measurement result, that Step 2 needs to be performed may be a method of the measurement event configuration information.

For Condition 2, the measurement event configuration information may include at least one of the following:
at least one sensing performance evaluation indicator satisfies a preset condition, for example, a sensing performance evaluation indicator that is of a sensing signal sent by a base station and that is measured by terminal 1 is lower than a preset threshold within a preset time period, or a quantity of times of lowering than the preset threshold within the preset time period reaches a preset quantity of times;
at least one sensing measurement quantity satisfies a preset condition, for example, a sensing measurement quantity that is of a sensing signal sent by a base station and that is measured by terminal 1 is lower than a preset threshold within a preset time period, or a quantity of times of lowering than the preset threshold within the preset time period reaches a preset quantity of times;
at least one sensing result does not satisfy a preset condition within a preset time period, for example, a downlink sensing result of the base station does not satisfy the preset condition within the preset time period;
parameter information of at least one sensing signal does not satisfy a minimum configuration requirement of sensing QoS;
a state of a sensing target changes (the state includes a location, a speed, and the like);
a location of UE participating in sensing changes, for example, moving out from a coverage area of the base station; or
an execution condition of partial switching.

The measurement event configuration information further includes a measurement object, such as parameter information and resource information of one or more first signals that are of a base station and that need to be measured.

For Condition 2, an example is that RSRP of the first signal is lower than a first threshold (for example, −100 dBm); or, for example, sensing SNR of the first signal is lower than a second threshold (for example, 5 dB); or, for example, an expected sensing object cannot be found in a delay Doppler spectrum obtained based on the first signal, or an amplitude of a delay Doppler spectrum related to a sensing object in the delay Doppler spectrum obtained based on the first signal does not reach an expected threshold. Then terminal 1 determines a satisfied measurement event, terminal 1 reports the measurement event to the base station, and the base station determines to perform Step 2.

For Condition 3, terminal 1 determines whether a sensing procedure needs to be switched to another terminal and reports that the network needs to be switched. A specific determining criterion includes at least one of the following:
power of terminal 1 is lower than a threshold;
terminal 1 has a more important service burst, such as a URLLC service; or
terminal 1 has a change in a physical state, an orientation, a motion direction, and the like.

It should be noted that in this embodiment, determining whether conditions and events occur may be based on a plurality of indicators or results at different times, to avoid randomness or ping-pong effect caused by determining based on a single result. In addition, a plurality of synchronization signals, reference signals, or sensing signals may correspond to a plurality of receive/transmit beam pairs.

Step 2: The base station or the core network device selects a new terminal (terminal 2), where a method for selecting the new terminal includes at least one of the following:
selecting a candidate terminal (set) based on at least one of location information, capability information, sensing subscription information, or state information;
the base station or the core network device indicates one or more candidate terminals to receive a second signal and report at least one of a communication-related indicator, a sensing-related indicator, a sensing measurement quantity, a sensing result, and a performance indicator of a target parameter of the second signal (configuration information of the signal is notified by the base station to the candidate terminal), or the base station or the core network device determines, based on whether these indicators and/or results satisfy corresponding thresholds or requirements respectively, whether the new terminal participates in sensing; or
the base station or the core network device notifies one or more candidate terminals of sending a second signal, the base station receives the second signal and obtains at least one of a communication-related indicator, a sensing-related indicator, a sensing measurement quantity, a sensing result, or a performance indicator of a target parameter of the second signal, and the base station or the core network device determines, based on whether these indicators and/or results satisfy corresponding thresholds or requirements respectively, whether the new terminal participates in sensing, where
the first signal includes at least one of a sensing signal, a reference signal, a synchronization signal, or a data signal, and the first signal is sent by the base station; and the second signal includes at least one of a preamble sequence, a sensing signal, a reference signal, or a data signal.

In addition, specific behaviors of terminal 2 may be different in a case of a connected state or an idle state, for example:
if being in an idle state or an inactive state, terminal 2 in the idle state first enters a connected state, and then receives a first signal or sends a second signal; or terminal 2 receives a first signal or sends a second signal in the idle state, such as sending the second signal or reporting at least one of a communication-related indicator, a sensing-related indicator, a sensing measurement quantity, a sensing result, or a performance indicator of a target parameter of the first signal by using message (Message, MSG) 1/3/A. If determining that the threshold is satisfied, the base station indicates terminal 2 to enter the connected state and participate in a subsequent sensing procedure.

Step 3: The base station or the core network device notifies one or more new terminals (terminal 2) of at least one of the following: a second signal configuration, a measurement quantity, a sensing context, a threshold, or the like.

The second signal configuration may include parameter information and resource information of a sensing signal;
the measurement quantity includes a sensing measurement quantity; and
the sensing context includes: a sensing measurement quantity, a sensing result, and the like of a target object obtained by terminal 1, such as a radar speed measurement/ranging/angle measurement result, a target frequency of breathing, and the like.

Step 4: One or more new terminals start to sense, for example:
receiving at least one of a synchronization signal, a reference signal, or a sensing signal sent by a base station; and
feeding back a sensing measurement quantity to the base station or the core network.

Step 5: The base station or the core network device notifies terminal 1 of exiting the sensing procedure.

Multi-user sensing measurement may not be combined, for example, at least one of sensing measurement quantities and measurement reports of terminal 1 and terminal 2 do not coincide in time; or
multi-user sensing measurement may be combined, for example, at least one of sensing measurement quantities and measurement reports of terminal 1 and terminal 2 coincide for a period of time, and in this case, the base station may combine at least one of measurement quantities and sensing results fed back by terminal 1 and terminal 2.

### Embodiment 2

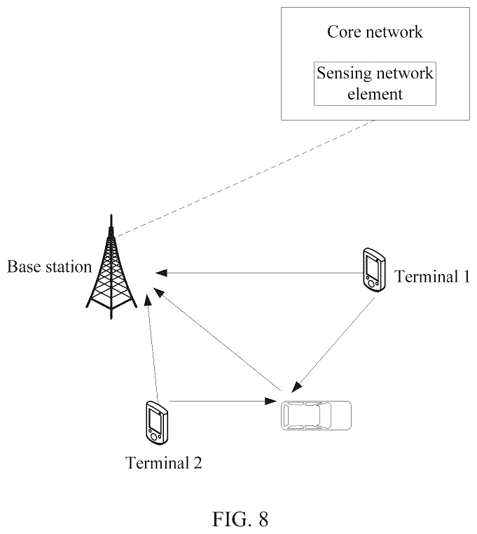

This embodiment uses an uplink sensing scenario shown in FIG. 8 as an example for description. A base station is unchanged in this scenario, and sensing by terminal 1 is switched to sensing by terminal 2. In this scenario, as shown in FIG. 8, when terminal 1 is a sensing terminal, terminal 1 sends uplink signals to the base station, and the base station receives two parts of the uplink signals. One part of the signals reaches the base station from terminal 1 through a line-of-sight path, and the other part of the signals is: the uplink signal sent by terminal 1 reaches the base station after being transmitted by a sensing target/object (such as a vehicle). When the sensing terminal is switched from terminal 1 to terminal 2, terminal 2 sends uplink signals to the base station, and the base station receives two parts of the uplink signals. One part of the signals reaches the base station from terminal 2 through a line-of-sight path, and the other part of the signals is: the uplink signal sent by terminal 2 reaches the base station after being transmitted by a sensing target/object (a vehicle). Sensing procedure switching may include the following steps.

Step 1: If at least one of the following three conditions is met, Step 2 is performed:

Condition 1: a base station or a core network device sends measurement configuration information to terminal 1 participating in sensing, terminal 1 performs measurement and reports a measurement result to the base station, and the base station determines, based on the measurement result, that Step 2 needs to be performed; or

Condition 2: a base station or a core network device sends measurement event configuration information to terminal 1 participating in sensing, and if terminal 1 finds a satisfied measurement event during measurement, terminal 1 reports the measurement event to the base station; or

Condition 3: terminal 1 determines whether a sensing procedure needs to be switched to another terminal, and reports it to a network; and

Condition 4: The base station determines, based on an indicator related to uplink sensing, whether to perform Step 2.

For Condition 4, the base station determines to perform Step 2 in at least one of the following cases:
a communication-related indicator of one or more second signals received by the base station is lower than a first threshold, where the communication-related indicator includes at least one of RSRP, SINR, RSRQ, or RSSI, for example, RSRP of the first signal is lower than the first threshold (−100 dBm);
a sensing-related indicator of one or more second signals received by the base station is lower than a second threshold, for example, sensing SNR of the second signal is lower than the second threshold (5 dB);
a sensing measurement quantity obtained by the base station by receiving one or more second signals does not satisfy a first requirement, for example, a measurement quantity related to the sensing object cannot be obtained by using the sensing measurement quantity, or the like;
a sensing result obtained by the base station by receiving one or more second signals does not satisfy a first requirement; or
a performance indicator of a target parameter obtained by the base station by receiving one or more second signals does not satisfy a second requirement, where
the second signal is at least one of a reference signal or a sensing signal, and the second signal is sent by terminal 1.

For Condition 1, the measurement configuration information may include at least one of the following:
a measurement object: for example, parameter information and resource information of one or more first signals that are of a base station and that need to be measured;
an MR configuration: the configuration includes: a reporting principle, which may be periodic reporting or the like; a type of reference signal for measurement or the like; a measurement report format, such as a maximum quantity of reported cells and a quantity of beams;
a measurement result/reported content: for example, a sensing performance evaluation indicator, a sensing measurement quantity, a sensing result, a state of a sensing target, a location of a terminal participating in sensing, and the like; or
a measurement ID: the measurement ID is used to associate a measurement object with a measurement report configuration.

The method that the base station determines, based on the measurement result, that Step 2 needs to be performed may be a method of the measurement event configuration information.

For Condition 2, the measurement event configuration information may include at least one of the following:
at least one sensing performance evaluation indicator satisfies a preset condition, for example, a sensing performance evaluation indicator that is of a sensing signal sent by a base station and that is measured by terminal 1 is lower than a preset threshold within a preset time period, or a quantity of times of lowering than the preset threshold within the preset time period reaches a preset quantity of times;
at least one sensing measurement quantity satisfies a preset condition, for example, a sensing measurement quantity that is of a sensing signal sent by a base station and that is measured by terminal 1 is lower than a preset threshold within a preset time period, or a quantity of times of lowering than the preset threshold within the preset time period reaches a preset quantity of times;
at least one sensing result does not satisfy a preset condition within a preset time period, for example, a downlink sensing result of the base station does not satisfy the preset condition within the preset time period;
parameter information of at least one sensing signal does not satisfy a minimum configuration requirement of sensing QoS;
a state of a sensing target changes (the state includes a location, a speed, and the like);
a location of a terminal participating in sensing changes, for example, moving out from a coverage area of the base station; or
an execution condition of partial switching.

The measurement event configuration information further includes a measurement object, such as parameter information and resource information of one or more first signals that are of a base station and that need to be measured.

For Condition 2, an example is that RSRP of the first signal is lower than a first threshold (for example, −100 dBm); or, for example, sensing SNR of the first signal is lower than a second threshold (for example, 5 dB); or, for example, an expected sensing object cannot be found in a delay Doppler spectrum obtained based on the first signal, or an amplitude of a delay Doppler spectrum related to a sensing object in the delay Doppler spectrum obtained based on the first signal does not reach an expected threshold. Then terminal 1 determines a satisfied measurement event, terminal 1 reports the measurement event to the base station, and the base station determines to perform Step 2.

For Condition 3, terminal 1 determines whether a sensing procedure needs to be switched to another terminal and reports that the network needs to be switched. A specific determining criterion includes at least one of the following:
power of terminal 1 is lower than a threshold;
terminal 1 has a more important service burst, such as a URLLC service; or
terminal 1 has a change in a physical state, an orientation, a motion direction, and the like.

It should be noted that in this embodiment, determining whether conditions and events occur may be based on a plurality of indicators or results at different times, to avoid randomness or ping-pong effect caused by determining based on a single result. In addition, a plurality of synchronization signals, reference signals, or sensing signals may correspond to a plurality of receive/transmit beam pairs (beam pair).

Step 2: The base station or the core network device selects a new terminal (terminal 2), where a method for selecting the new terminal includes at least one of the following:
selecting a candidate terminal (set) based on at least one of location information, capability information, sensing subscription information, or state information;
the base station or the core network device indicates one or more candidate terminals to receive a first signal and report at least one of a communication-related indicator, a sensing-related indicator, a sensing measurement quantity, a sensing result, or a performance indicator of a target parameter of the first signal (configuration information of the signal is notified by the base station to the candidate terminal), and the base station or the core network device determines, based on whether these indicators and/or results satisfy corresponding thresholds or requirements respectively, whether the new terminal participates in sensing; or
the base station or the core network device notifies one or more candidate terminals of sending a second signal, the base station receives the second signal and obtains at least one of a communication-related indicator, a sensing-related indicator, a sensing measurement quantity, a sensing result, or a performance indicator of a target parameter of the second signal, and the base station or the core network device determines, based on whether these indicators and/or results satisfy corresponding thresholds or requirements respectively, whether the new terminal participates in sensing, where
the first signal includes at least one of a sensing signal, a reference signal, a synchronization signal, or a data signal, and the first signal is sent by the base station; and the second signal includes at least one of a preamble sequence, a sensing signal, a reference signal, or a data signal.

In addition, specific behaviors of terminal 2 may be different in a case of a connected state or an idle state, for example:
if being in an idle state or an inactive state, terminal 2 first needs to enter a connected state, and then receives a first signal or sends a second signal; or terminal 2 receives a first signal or sends a second signal in the idle state (sending the second signal or reporting at least one of a communication-related indicator, a sensing-related indicator, a sensing measurement quantity, a sensing result, or a performance indicator of a target parameter of the first signal by using MSG1/3/A). If determining that the threshold is satisfied, the base station indicates terminal 2 to enter the connected state and participate in a subsequent sensing procedure.

Step 3: The base station or the core network device notifies one or more new terminals (terminal 2) of at least one of the following: a second signal configuration, a measurement quantity, a sensing context, a threshold, or the like.

The second signal configuration may include parameter information and resource information of a sensing signal;
the measurement quantity includes a sensing measurement quantity; and
the sensing context includes: a sensing measurement quantity, a sensing result, and the like of a target object obtained by the base station by receiving a signal sent by terminal 1 (such as a radar speed measurement/ranging/angle measurement result, a target frequency of breathing, and the like).

Step 4: One or more new terminals start to sense, for example:
sending at least one of a preamble sequence, a reference signal, or a sensing signal.

Step 5: The base station or the core network device notifies terminal 1 of exiting the sensing procedure.

Multi-user sensing measurement may not be combined, for example, moments at which terminal 1 and terminal 2 send at least one of the preamble sequence, the reference signal, and the sensing signal does not coincide.

Multi-user sensing measurement may be combined, for example, moments at which terminal 1 and terminal 2 send at least one of the preamble sequence, the reference signal, and the sensing signal coincide for a period of time, and in this case, the base station or the core network device may combine at least one of measurement quantities and sensing results obtained by receiving signals sent by terminal 1 and terminal 2.

### Embodiment 3

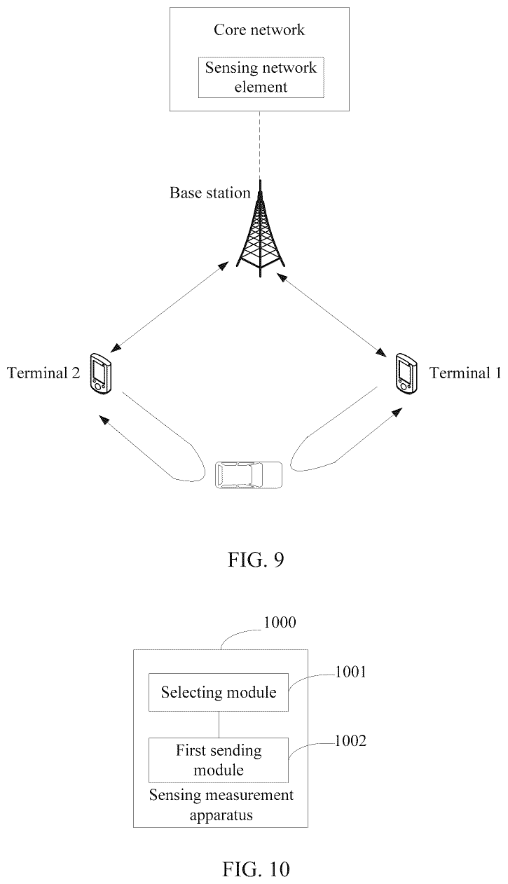

This embodiment uses a self-transmit self-receive sensing scenario of a terminal shown in FIG. 9 as an example for description. A base station is unchanged in this scenario, and sensing by terminal 1 is switched to sensing by terminal 2. In this scenario, as shown in FIG. 9, when terminal 1 is a sensing terminal, terminal 1 sends a signal, and the signal is transmitted back to terminal 1 via a sensing target/object (such as a vehicle), that is, terminal 1 performs self-transmit self-receive. When the sensing terminal is switched from terminal 1 to terminal 2, terminal 2 sends a signal, and the signal is transmitted back to terminal 2 via a sensing target/object (such as a vehicle), that is, terminal 2 performs self-transmit self-receive. Sensing procedure switching may include the following steps.

Step 1: If at least one of the following three conditions is met, Step 2 is performed:

Condition 1: a base station or a core network device sends measurement configuration information to terminal 1 participating in sensing, terminal 1 performs measurement and reports a measurement result to the base station, and the base station determines, based on the measurement result, that Step 2 needs to be performed; or

Condition 2: a base station or a core network device sends measurement event configuration information to terminal 1 participating in sensing, and if terminal 1 finds a satisfied measurement event during measurement, terminal 1 reports the measurement event to the base station; or

Condition 3: terminal 1 determines whether a sensing procedure needs to be switched to another terminal, and reports it to a network; and

Condition 4: a base station or a core network device sends measurement configuration information to terminal 1 participating in sensing, terminal 1 performs measurement and reports a measurement result to the base station, and the base station determines, based on the measurement result, that Step 2 needs to be performed, where the measurement result includes at least one of the following:
a communication-related indicator of one or more second signals received by terminal 1 is lower than a first threshold, where the communication-related indicator includes at least one of RSRP, SINR, RSRQ, or RSSI, for example, RSRP of the first signal is lower than the first threshold (−100 dBm);
a sensing-related indicator of one or more second signals received by terminal 1 is lower than a second threshold, for example, sensing SNR of the first signal is lower than the second threshold (5 dB);
a sensing measurement quantity obtained by terminal 1 by receiving one or more second signals does not satisfy a first requirement, for example, a measurement quantity related to the sensing object cannot be obtained by using the sensing measurement quantity, or the like;
a sensing result obtained by terminal 1 by receiving one or more second signals does not satisfy a first requirement; or
a performance indicator of a target parameter obtained by terminal 1 by receiving one or more second signals does not satisfy a second requirement.

The first signal includes at least one of a reference signal or a sensing signal, and the first signal is sent by terminal 1, where
for Condition 1, the measurement configuration information may include at least one of the following:
a measurement object: for example, parameter information and resource information of one or more first signals that are of a base station and that need to be measured;
an MR configuration: the configuration includes: a reporting principle, which may be periodic reporting or the like; a type of reference signal for measurement or the like; a measurement report format, such as a maximum quantity of reported cells and a quantity of beams;
a measurement result/reported content: for example, a sensing performance evaluation indicator, a sensing measurement quantity, a sensing result, a state of a sensing target, a location of a terminal participating in sensing, and the like; or
a measurement ID: the measurement ID is used to associate a measurement object with a measurement report configuration.

The method that the base station determines, based on the measurement result, that Step 2 needs to be performed may be a method of the measurement event configuration information.

For Condition 2, the measurement event configuration information may include at least one of the following:
at least one sensing performance evaluation indicator satisfies a preset condition, for example, a sensing performance evaluation indicator that is of a second signal sent by terminal 1 and that is measured by terminal 1 is lower than a preset threshold within a preset time period, or a quantity of times of lowering than the preset threshold within the preset time period reaches a preset quantity of times;
at least one sensing measurement quantity satisfies a preset condition, for example, a sensing measurement quantity that is of a second signal sent by terminal 1 and that is measured by terminal 1 is lower than a preset threshold within a preset time period, or a quantity of times of lowering than the preset threshold within the preset time period reaches a preset quantity of times;
at least one sensing result does not satisfy a preset condition within a preset time period, for example, a sensing result based on self-transmit self-receive of terminal 1 does not satisfy the preset condition within the preset time period;
parameter information of at least one sensing signal does not satisfy a minimum configuration requirement of sensing QoS;
a state of a sensing target changes (the state includes a location, a speed, and the like); or
a location of a terminal participating in sensing changes, for example, moving out from a region near a sensing target.

The measurement event configuration information further includes a measurement object, such as parameter information and resource information of one or more second signals that are sent by terminal 1 and that need to be measured.

For Condition 2, an example is that RSRP of the second signal is lower than a first threshold (for example, −100 dBm); or, for example, sensing SNR of the first signal is lower than a second threshold (for example, 5 dB); or, for example, an expected sensing object cannot be found in a delay Doppler spectrum obtained based on the second signal, or an amplitude of a delay Doppler spectrum related to a sensing object in the delay Doppler spectrum obtained based on the second signal does not reach an expected threshold. Then terminal 1 determines a satisfied measurement event, terminal 1 reports the measurement event to the base station, and the base station determines to perform Step 2.

For Condition 3, terminal 1 determines whether a sensing procedure needs to be switched to another terminal and reports that the network needs to be switched. A specific determining criterion includes at least one of the following:
power of terminal 1 is lower than a threshold;
terminal 1 has a more important service burst, such as a URLLC service; or terminal 1 has a change in a physical state, an orientation, a motion direction, and the like.

It should be noted that in this embodiment, determining whether conditions and events occur may be based on a plurality of indicators or results at different times, to avoid randomness or ping-pong effect caused by determining based on a single result. In addition, a plurality of synchronization signals, reference signals, or sensing signals may correspond to a plurality of receive/transmit beam pairs (beam pair).

Step 2: The base station or the core network device selects one or more new terminals (terminal 2), where a method for selecting the new terminal includes at least one of the following:
selecting a candidate terminal (set) based on at least one of location information, capability information, sensing subscription information, or state information;
the base station or the core network device indicates one or more candidate terminals to receive a first signal and report at least one of a communication-related indicator, a sensing-related indicator, a sensing measurement quantity, a sensing result, or a performance indicator of a target parameter of the first signal (configuration information of the signal is notified by the base station to candidate UE), and the base station or the core network device determines, based on whether these indicators and/or results satisfy corresponding thresholds or requirements respectively, whether the new terminal participates in sensing; or
the base station or the core network device notifies one or more candidate terminals of sending a second signal, and receives a second signal sent by the base station or the core network device, to obtain at least one of a communication-related indicator, a sensing-related indicator, a sensing measurement quantity, and a sensing result, or a performance indicator of a target parameter of the second signal, and the base station or the core network device determines, based on whether these indicators and/or results satisfy corresponding thresholds or requirements respectively, whether the new terminal participates in sensing, where
the first signal includes at least one of a sensing signal, a reference signal, a synchronization signal, or a data signal, and the first signal is sent by the base station; and the second signal includes at least one of a preamble sequence, a reference signal, or a data signal which are sent by the terminal.

In addition, specific behaviors of terminal 2 may be different in a case of a connected state or an idle state, for example:
if being in an idle state or an inactive state, terminal 2 in the idle state first needs to enter a connected state, and then receives a first signal or sends a second signal; or terminal 2 receives a first signal or sends a second signal in the idle state (sending the second signal or reporting at least one of a communication-related indicator, a sensing-related indicator, a sensing measurement quantity, a sensing result, or a performance indicator of a target parameter of the first signal by using MSG1/3/A). If determining that the threshold is satisfied, the base station or the core network device indicates terminal 2 to enter the connected state and participate in a subsequent sensing procedure.

Step 3: The base station or the core network device notifies one or more new terminals (terminal 2) of at least one of the following: an uplink signal configuration, a measurement quantity, a sensing context, a threshold, or the like.

The uplink signal configuration may include parameter information and resource information of a sensing signal (explanation 2);
the measurement quantity includes a sensing measurement quantity; and
the sensing context includes: a sensing measurement quantity, a sensing result, and the like of a target object obtained by the base station by receiving a signal sent by terminal 1 (such as a radar speed measurement/ranging/angle measurement result, a target frequency of breathing, and the like).

Step 4: One or more new terminals start to sense, for example:
sending at least one of a preamble sequence, a reference signal, or a sensing signal.

Step 5: The base station or the core network device notifies terminal 1 of exiting the sensing procedure.

Multi-user sensing measurement may not be combined, for example, moments at which terminal 1 and terminal 2 send at least one of the preamble sequence, the reference signal, and the sensing signal does not coincide.

Multi-user sensing measurement may be combined, for example, moments at which terminal 1 and terminal 2 send at least one of the preamble sequence, the reference signal, and the sensing signal coincide for a period of time, and in this case, the base station or the core network device may combine at least one of measurement quantities and sensing results corresponding to signals sent by terminal 1 and terminal 2.

It should be noted that the embodiments mainly describe switching procedures of terminals participating in sensing in the same cell, and these procedures can ensure continuity of the sensing service.

The sensing measurement method provided in this embodiment of this application may be executed by a sensing measurement apparatus. In this embodiment of this application, that the sensing measurement apparatus performs sensing measurement is used as an example to describe the sensing measurement apparatus provided in the embodiments of this application.

Referring to FIG. 10, FIG. 10 is a structural diagram of a sensing measurement apparatus according to an embodiment of this application. As shown in FIG. 10, the sensing measurement apparatus 1000 includes:
a selecting module 1001, configured to select a first terminal in a case that a sensing terminal is determined to be changed; and
a first sending module 1002, configured to send a notification message to the first terminal, where the notification message is used to notify the first terminal of performing a sensing operation.

In some embodiments, the selecting module 1001 is configured to select the first terminal in a case that the first device determines, based on association information of a second terminal, to change the sensing terminal, where change of the sensing terminal includes changing the second terminal to the first terminal.

In some embodiments, the association information of the second terminal includes at least one of the following:
a measurement result that is of a first signal sent by the first device and that is reported by the second terminal;
sensing terminal change information reported by the second terminal;
a measurement result that is of a second signal sent by the second terminal and that is obtained by the first device; or
a measurement result of the second signal reported by the second terminal, where
the first signal includes at least one of a sensing signal, a reference signal, a synchronization signal, or a data signal; and the second signal includes at least one of a sensing signal, a reference signal, or a data signal.

In some embodiments, the apparatus further includes:
a second sending module, configured to send first measurement configuration information to the second terminal, where
the first measurement configuration information includes at least one of the following:
a measurement object, where the measurement object includes configuration information of the first signal;
measurement report configuration information, where the measurement report configuration information includes at least one of the following: a reporting manner, a type of a reference signal used for measurement, or measurement report content; the reporting manner includes periodic reporting or reporting triggered by a measurement event; and the measurement report content includes at least one of the following: a communication-related indicator, a sensing-related indicator, a sensing measurement quantity, a sensing result, or a performance indicator of a target parameter; or
a measurement identifier, where one measurement identifier is used to associate at least one measurement object and at least one piece of the measurement report configuration information; and
in a case that the reporting manner includes reporting triggered by a measurement event, the first measurement configuration information further includes a measurement event.

In some embodiments, the measurement event includes at least one of the following:
at least one sensing-related indicator satisfies a first preset condition;
at least one sensing measurement quantity satisfies a second preset condition;
at least one sensing result satisfies a third preset condition;
at least one parameter of a sensing signal satisfies a fourth preset condition;
a state of a sensing target changes;
a location of the second terminal changes; or
at least one communication-related indicator of a non-serving cell and/or serving cell of the second terminal satisfies a fifth preset condition.

In some embodiments, the sensing-related indicator includes at least one of the following:
a sensing signal to noise ratio (SNR), a sensing signal to interference plus noise ratio (SINR), statistics on a plurality of measurement results of a sensing measurement quantity, deviation information between a predicted value and an actual measurement value of a sensing measurement quantity, deviation information between a predicted value and an actual measurement value of a measurement result, similar information of a signal sequence, or an echo signal power.

In some embodiments, the measurement result of the second signal is used to represent at least one of the following:
a communication-related indicator of the second signal received by the second terminal;
a sensing-related indicator of the second signal received by the second terminal;
a sensing measurement quantity obtained by the second terminal by using the received second signal;
a sensing result obtained by the second terminal by using the received second signal; or
a performance indicator of a target parameter obtained by the second terminal by using the received second signal, where
the second signal is a signal sent and received by the second terminal.

In some embodiments, the target parameter includes at least one of the following:
a target parameter in a polar coordinate system and a target parameter in an inertial system; and
the performance indicator of the target parameter includes at least one of the following:
a variance of a residual of the target parameter, a standard deviation of a residual of the target parameter, a covariance of a prediction error of the target parameter, or a covariance of a state estimation error of the target parameter.

In some embodiments, the measurement result that is of the second signal sent by the second terminal and that is obtained by the first device is used to represent at least one of the following:
a communication-related indicator of the second signal received by the first device;
a sensing-related indicator of the second signal received by the first device;
a sensing measurement quantity obtained by the first device by using the received second signal;
a sensing result obtained by the first device by using the received second signal; or
a performance indicator of a target parameter obtained by the first device by using the received second signal, where
the second signal is a signal sent by the second terminal.

In some embodiments, the selecting the first terminal includes:
selecting, based on association information of a candidate terminal, the first terminal from the candidate terminal, where
the association information of the candidate terminal includes at least one of the following:
terminal information of the candidate terminal;
measurement information of a first signal received by the candidate terminal; or
measurement information of a second signal sent by the candidate terminal.

In some embodiments, the terminal information includes at least one of the following: location information, capability information, sensing subscription information, and state information;
and/or
the measurement information includes:
a communication-related indicator, a sensing-related indicator, a sensing measurement quantity, a sensing result, and a performance indicator of a target parameter.

In some embodiments, the notification message includes at least one of the following: configuration information of the second signal;
a sensing measurement quantity;
a sensing context; or
a threshold, where
the configuration information of the second signal includes at least one of the following: parameter information or resource information;
the sensing context includes at least one of the following: a sensing measurement quantity associated with the second terminal or a sensing result associated with the second terminal; and
the threshold is a discrimination threshold for sensing.

In some embodiments, the apparatus further includes at least one of the following:
a third sending module, configured to send a notification message for stopping the sensing operation to the second terminal;
a first obtaining module, configured to obtain a sensing measurement quantity for the sensing target based on a sensing measurement quantity associated with the second terminal and a sensing measurement quantity associated with the first terminal; or
a second obtaining module, configured to obtain a sensing result for the sensing target based on a sensing result associated with the second terminal and a sensing result associated with the first terminal.

In some embodiments, the sensing operation includes one of the following:
receiving a first signal and feeding back a sensing measurement quantity related to the first signal;
sending a second signal; or
sending a second signal, receiving the second signal, and feeding back a sensing measurement quantity related to the second signal.

The foregoing sensing measurement apparatus may improve flexibility of sensing measurement.

The sensing measurement apparatus in this embodiment of this application may be an electronic device, for example, an electronic device with an operating system, or may be a component in the electronic device, for example, an integrated circuit or a chip. For example, the electronic device may be a network side device, or another device other than the network side device. For example, the network side device may include but is not limited to the types of network side devices listed in this embodiment of this application, and the another device may be a server, a Network Attached Storage (NAS), or the like. This is not specifically limited in this embodiment of this application.

The sensing measurement apparatus provided in this embodiment of this application can implement the processes implemented in the method embodiment shown in FIG. 3, and achieve a same technical effect. To avoid repetition, details are not described herein again.

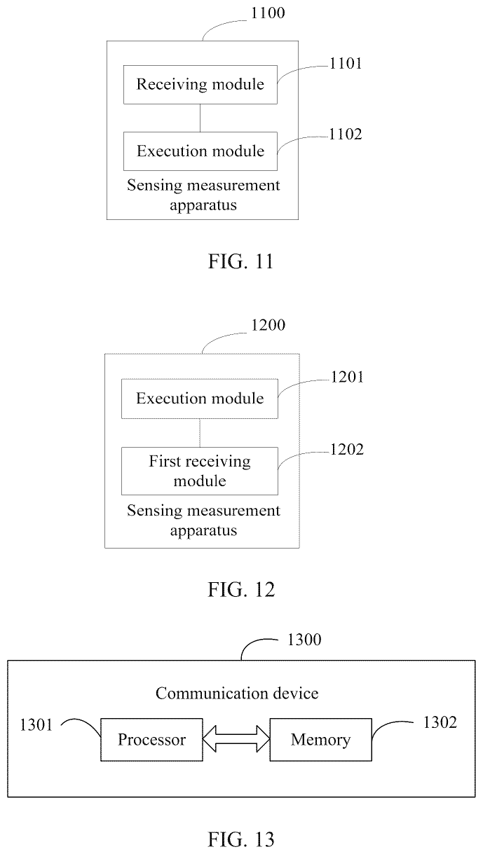

Referring to FIG. 11, FIG. 11 is a structural diagram of another sensing measurement apparatus according to an embodiment of this application. As shown in FIG. 11, the sensing measurement apparatus 1100 includes:
a receiving module 1101, configured to receive a notification message sent by a first device, where the notification message is used to notify a first terminal of performing a sensing operation; and
an execution module 1102, configured to perform the sensing operation based on the notification message.

In some embodiments, the apparatus further includes at least one of the following:
a first sending module, configured to send terminal information of the first terminal to the first device;
a second sending module, configured to send measurement information to the first device, where the measurement information is information obtained by the first terminal by measuring a received first signal; or
sending, by the first terminal, a second signal to the first device.

In some embodiments, the terminal information includes at least one of the following: location information, capability information, sensing subscription information, and state information;
and/or
the measurement information includes at least one of the following:
a communication-related indicator, a sensing-related indicator, a sensing measurement quantity, a sensing result, or a performance indicator of a target parameter.

In some embodiments, in a case that the first terminal is in an idle state or an inactive state, the first terminal enters a connected state to receive the first signal or send the second signal; or
the first terminal receives the first signal or sends the second signal in the idle state.

In some embodiments, the notification message includes at least one of the following: configuration information of the second signal;
a sensing measurement quantity;
a sensing context; or
a threshold, where
the configuration information of the second signal includes at least one of the following: parameter information or resource information;
the sensing context includes at least one of the following: a sensing measurement quantity associated with a second terminal or a sensing result associated with the second terminal, where the second terminal is a sensing terminal that performs a sensing operation before the first terminal performs the sensing operation; and
the threshold is a discrimination threshold for sensing.

In some embodiments, the sensing operation includes one of the following:
receiving a first signal and feeding back a sensing measurement quantity related to the first signal;
sending a second signal; or sending a second signal, receiving the second signal, and feeding back a sensing measurement quantity related to the second signal.

The foregoing sensing measurement apparatus may improve flexibility of sensing measurement.

The sensing measurement apparatus in this embodiment of this application may be an electronic device, for example, an electronic device with an operating system, or may be a component in the electronic device, for example, an integrated circuit or a chip. For example, the electronic device may be a terminal, or another device other than the terminal. For example, the terminal may include but is not limited to the types of terminals listed in this embodiment of this application, and the another device may be a server, a Network Attached Storage (NAS), or the like. This is not specifically limited in this embodiment of this application.

The sensing measurement apparatus provided in this embodiment of this application can implement the processes implemented in the method embodiment shown in FIG. 5, and achieve a same technical effect. To avoid repetition, details are not described herein again.

Referring to FIG. 12, FIG. 12 is a structural diagram of another sensing measurement apparatus according to an embodiment of this application. As shown in FIG. 12, the sensing measurement apparatus 1200 includes:
an execution module 1201, configured to perform a sensing operation; and
a first receiving module 1202, configured to receive a notification message for stopping the sensing operation sent by a first device.

In some embodiments, the notification message is sent based on association information of the second terminal.

In some embodiments, the association information of the second terminal includes at least one of the following:
a measurement result that is of a first signal sent by the first device and that is reported by the second terminal;
sensing terminal change information reported by the second terminal;
a measurement result that is of a second signal sent by the second terminal and that is obtained by the first device; and
a measurement result of the second signal reported by the second terminal, where
the first signal includes at least one of a sensing signal, a reference signal, a synchronization signal, and a data signal; and the second signal includes at least one of a sensing signal, a reference signal, and a data signal.

In some embodiments, the method further includes:
a second receiving module, configured to obtain first measurement configuration information sent by the first device, where
the first measurement configuration information includes at least one of the following:
a measurement object, where the measurement object includes configuration information of the first signal;
measurement report configuration information, where the measurement report configuration information includes at least one of the following: a reporting manner, a type of a reference signal used for measurement, and measurement report content; the reporting manner includes periodic reporting or reporting triggered by a measurement event; and the measurement report content includes at least one of the following: a communication-related indicator, a sensing-related indicator, a sensing measurement quantity, a sensing result, and a performance indicator of a target parameter; and
a measurement identifier, where one measurement identifier is used to associate at least one measurement object and at least one piece of the measurement report configuration information; and
in a case that the reporting manner includes reporting triggered by a measurement event, the first measurement configuration information further includes a measurement event.

In some embodiments, the measurement configuration information includes at least one of the following:
the measurement event includes at least one of the following:
at least one sensing-related indicator satisfies a first preset condition;
at least one sensing measurement quantity satisfies a second preset condition;
at least one sensing result satisfies a third preset condition;
at least one parameter of a sensing signal satisfies a fourth preset condition;
a state of a sensing target changes;
a location of the second terminal changes; and
at least one communication-related indicator of a non-serving cell and/or serving cell of the second terminal satisfies a fifth preset condition.

In some embodiments, the sensing-related indicator includes at least one of the following:
a sensing signal to noise ratio (SNR), a sensing signal to interference plus noise ratio (SINR), statistics on a plurality of measurement results of a sensing measurement quantity, deviation information between a predicted value and an actual measurement value of a sensing measurement quantity, deviation information between a predicted value and an actual measurement value of a measurement result, similar information of a signal sequence, and an echo signal power.

In some embodiments, the measurement result of the second signal is used to represent at least one of the following:
a communication-related indicator of the second signal received by the second terminal;
a sensing-related indicator of the second signal received by the second terminal;
a sensing measurement quantity obtained by the second terminal by using the received second signal;
a sensing result obtained by the second terminal by using the received second signal; and
a performance indicator of a target parameter obtained by the second terminal by using the received second signal, where
the second signal is a signal sent and received by the second terminal.

In some embodiments, the target parameter includes at least one of the following:
a target parameter in a polar coordinate system and a target parameter in an inertial system; and
the performance indicator of the target parameter includes at least one of the following:
a variance of a residual of the target parameter, a standard deviation of a residual of the target parameter, a covariance of a prediction error of the target parameter, and a covariance of a state estimation error of the target parameter.

In some embodiments, the sensing terminal change information reported by the second terminal is reported by the second terminal based on at least one of the following: power of the second terminal;
a service of the second terminal;
a physical state of the second terminal;
an orientation of the second terminal; and
a motion direction of the second terminal.

The foregoing sensing measurement apparatus may improve flexibility of sensing measurement.

The sensing measurement apparatus in this embodiment of this application may be an electronic device, for example, an electronic device with an operating system, or may be a component in the electronic device, for example, an integrated circuit or a chip. For example, the electronic device may be a terminal, or another device other than the terminal. For example, the terminal may include but is not limited to the types of terminals listed in this embodiment of this application, and the another device may be a server, a Network Attached Storage (NAS), or the like. This is not specifically limited in this embodiment of this application.

The sensing measurement apparatus provided in this embodiment of this application can implement the processes implemented in the method embodiment shown in FIG. 5, and achieve a same technical effect. To avoid repetition, details are not described herein again.

As shown in FIG. 13, an embodiment of this application further provides a communication device 1300, including a processor 1301 and a memory 1302. The memory 1302 stores a program or an instruction that can be run on the processor 1301. For example, in a case that the communication device 1300 is a first device, when the program or the instruction is executed by the processor 1301, the steps of the foregoing information feedback method embodiment are implemented, and a same technical effect can be achieved. In a case that the communication device 1300 is a second device, when the program or the instruction is executed by the processor 1301, the steps of the foregoing information obtaining method embodiment are implemented, and a same technical effect can be achieved. To avoid repetition, details are not described herein again.

An embodiment of this application further provides a communication device, and the communication device is a first device, including a processor and a communication interface, where the processor is configured to select a first terminal in a case that a sensing terminal is determined to be changed; and the communication interface sends a notification message to the first terminal, where the notification message is used to notify the first terminal of performing a sensing operation. This first device embodiment is corresponding to the foregoing first device side method embodiment. Each implementation process and implementation of the foregoing method embodiment may be applicable to this first device embodiment, and a same technical effect can be achieved.

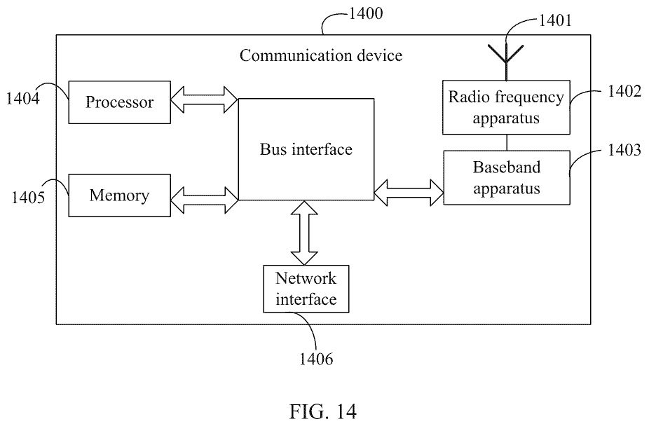

An embodiment of this application further provides a communication device, and the communication device is a first device. As shown in FIG. 14, the communication device 1400 includes an antenna 1401, a radio frequency apparatus 1402, a baseband apparatus 1403, a processor 1404, and a memory 1405. The antenna 1401 is connected to the radio frequency apparatus 1402. In an uplink direction, the radio frequency apparatus 1402 receives information through the antenna 1401, and sends the received information to the baseband apparatus 1403 for processing. In a downlink direction, the baseband apparatus 1403 processes information that needs to be sent, and sends processed information to the radio frequency apparatus 1402. The radio frequency apparatus 1402 processes the received information, and sends processed information through the antenna 1401.

In the foregoing embodiment, the method performed by the communication device may be implemented in a baseband apparatus 1403. The baseband apparatus 1403 includes a baseband processor.

For example, the baseband apparatus 1403 may include at least one baseband board. A plurality of chips are disposed on the baseband board. As shown in FIG. 14, one chip is, for example, a baseband processor, and is connected to the memory 1405 by using a bus interface, to invoke a program in the memory 1405 to perform the operations of the network device shown in the foregoing method embodiment.

The communication device may further include a network interface 1406, and the interface is, for example, a common public radio interface (CPRI).

The communication device 1400 in this embodiment of this application further includes an instruction or a program that is stored in the memory 1405 and that can run on the processor 1404. The processor 1404 invokes the instruction or the program in the memory 1405 to perform the method performed by the modules shown in FIG. 4, and a same technical effect is achieved. To avoid repetition, details are not described herein again.

The processor 1404 is configured to select a first terminal in a case that a sensing terminal is determined to be changed; and
the radio frequency apparatus 1402 is configured to send a notification message to the first terminal, where the notification message is used to notify the first terminal of performing a sensing operation.

In some embodiments, the selecting a first terminal in a case that a sensing terminal is determined to be changed includes:
selecting the first terminal in a case that the first device determines, based on association information of a second terminal, to change the sensing terminal, where
change of the sensing terminal includes changing the second terminal to the first terminal.

In some embodiments, the association information of the second terminal includes at least one of the following:
a measurement result that is of a first signal sent by the first device and that is reported by the second terminal;
sensing terminal change information reported by the second terminal;
a measurement result that is of a second signal sent by the second terminal and that is obtained by the first device; and
a measurement result of the second signal reported by the second terminal, where
the first signal includes at least one of a sensing signal, a reference signal, a synchronization signal, and a data signal; and the second signal includes at least one of a sensing signal, a reference signal, and a data signal.

In some embodiments, the radio frequency apparatus 1402 is further configured to send first measurement configuration information to the second terminal, where
the first measurement configuration information includes at least one of the following:
a measurement object, where the measurement object includes configuration information of the first signal;
measurement report configuration information, where the measurement report configuration information includes at least one of the following: a reporting manner, a type of a reference signal used for measurement, and measurement report content; the reporting manner includes periodic reporting or reporting triggered by a measurement event; and the measurement report content includes at least one of the following: a communication-related indicator, a sensing-related indicator, a sensing measurement quantity, a sensing result, and a performance indicator of a target parameter; and
a measurement identifier, where one measurement identifier is used to associate at least one measurement object and at least one piece of the measurement report configuration information; and
in a case that the reporting manner includes reporting triggered by a measurement event, the first measurement configuration information further includes a measurement event.

In some embodiments, the measurement event includes at least one of the following: at least one sensing-related indicator satisfies a first preset condition;
at least one sensing measurement quantity satisfies a second preset condition;
at least one sensing result satisfies a third preset condition;
at least one parameter of a sensing signal satisfies a fourth preset condition;
a state of a sensing target changes;
a location of the second terminal changes; and
at least one communication-related indicator of a non-serving cell and/or serving cell of the second terminal satisfies a fifth preset condition.

In some embodiments, the sensing-related indicator includes at least one of the following:
a sensing signal to noise ratio (SNR), a sensing signal to interference plus noise ratio (SINR), statistics on a plurality of measurement results of a sensing measurement quantity, deviation information between a predicted value and an actual measurement value of a sensing measurement quantity, deviation information between a predicted value and an actual measurement value of a measurement result, similar information of a signal sequence, and an echo signal power.

In some embodiments, the measurement result of the second signal is used to represent at least one of the following:
a communication-related indicator of the second signal received by the second terminal;
a sensing-related indicator of the second signal received by the second terminal;
a sensing measurement quantity obtained by the second terminal by using the received second signal;
a sensing result obtained by the second terminal by using the received second signal; and
a performance indicator of a target parameter obtained by the second terminal by using the received second signal, where
the second signal is a signal sent and received by the second terminal.

In some embodiments, the target parameter includes at least one of the following:
a target parameter in a polar coordinate system and a target parameter in an inertial system; and
the performance indicator of the target parameter includes at least one of the following:
a variance of a residual of the target parameter, a standard deviation of a residual of the target parameter, a covariance of a prediction error of the target parameter, and a covariance of a state estimation error of the target parameter.

In some embodiments, the measurement result that is of the second signal sent by the second terminal and that is obtained by the first device is used to represent at least one of the following:
a communication-related indicator of the second signal received by the first device;
a sensing-related indicator of the second signal received by the first device;
a sensing measurement quantity obtained by the first device by using the received second signal;
a sensing result obtained by the first device by using the received second signal; and
a performance indicator of a target parameter obtained by the first device by using the received second signal, where
the second signal is a signal sent by the second terminal.

In some embodiments, the selecting the first terminal includes:
selecting, based on association information of a candidate terminal, the first terminal from the candidate terminal, where
the association information of the candidate terminal includes at least one of the following:
terminal information of the candidate terminal;
measurement information of a first signal received by the candidate terminal; and
measurement information of a second signal sent by the candidate terminal.

In some embodiments, the terminal information includes at least one of the following:
location information, capability information, sensing subscription information, and state information;
and/or
the measurement information includes:
a communication-related indicator, a sensing-related indicator, a sensing measurement quantity, a sensing result, and a performance indicator of a target parameter.

In some embodiments, the notification message includes at least one of the following: configuration information of the second signal;
a sensing measurement quantity;
a sensing context; and
a threshold, where
the configuration information of the second signal includes at least one of the following: parameter information and resource information;
the sensing context includes at least one of the following: a sensing measurement quantity associated with the second terminal and a sensing result associated with the second terminal; and
the threshold is a discrimination threshold for sensing.

In some embodiments, the radio frequency apparatus 1402 is further configured to send a notification message for stopping the sensing operation to the second terminal;
the processor 1404 is further configured to obtain a sensing measurement quantity for the sensing target based on a sensing measurement quantity associated with the second terminal and a sensing measurement quantity associated with the first terminal; and
the processor 1404 is further configured to obtain a sensing result for the sensing target based on a sensing result associated with the second terminal and a sensing result associated with the first terminal.

In some embodiments, the sensing operation includes one of the following:
receiving a first signal and feeding back a sensing measurement quantity related to the first signal;
sending a second signal; and
sending a second signal, receiving the second signal, and feeding back a sensing measurement quantity related to the second signal.

The first device may improve flexibility of sensing measurement.

An embodiment of this application further provides a communication device, and the communication device is a first terminal, including a processor and a communication interface, where the communication interface is configured to: receive a notification message sent by a first device, where the notification message is used to notify the first terminal of performing a sensing operation; and perform the sensing operation based on the notification message. The first terminal embodiment is corresponding to the first terminal side method embodiment, each implementation process and implementation of the method embodiment can be applied to the first terminal embodiment, and a same technical effect can be achieved.

An embodiment of this application further provides a communication device, and the communication device is a second terminal, including a processor and a communication interface, where the communication interface is configured to: perform a sensing operation; and receive a notification message for stopping the sensing operation sent by a first device. The second terminal embodiment is corresponding to the second terminal side method embodiment, each implementation process and implementation of the method embodiment may be applied to the second terminal embodiment, and a same technical effect can be achieved.

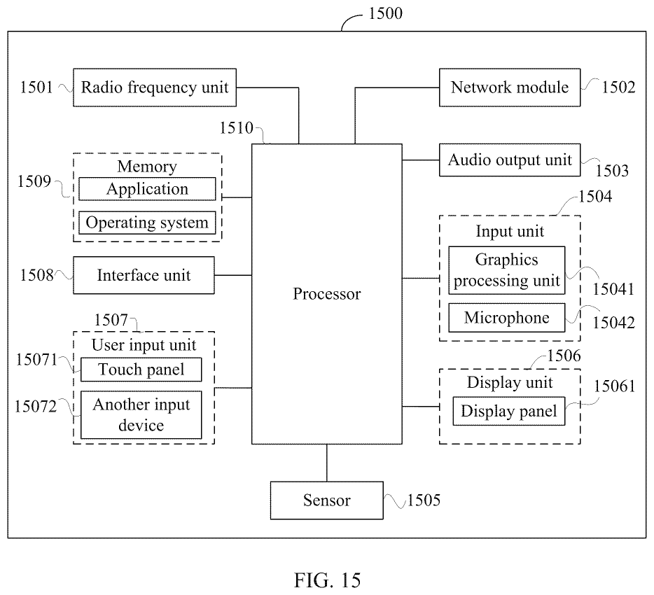

FIG. 15 is a schematic diagram of a hardware structure of a terminal according to an embodiment of this application.

The terminal 1500 includes but is not limited to at least a part of components of a radio frequency unit 1501, a network module 1502, an audio output unit 1503, an input unit 1504, a sensor 1505, a display unit 1506, a user input unit 1507, an interface unit 1508, a memory 1509, a processor 1510, and the like.

A person skilled in the art can understand that the terminal 1500 may further include a power supply (such as a battery) that supplies power to each component. The power supply may be logically connected to the processor 1510 by using a power supply management system, to implement functions such as charging and discharging management, and power consumption management by using the power supply management system. The terminal structure shown in FIG. 15 constitutes no limitation on the terminal, and the terminal may include more or fewer components than those shown in the figure, or combine some components, or have different component arrangements. Details are not described herein.

It should be understood that, in this embodiment of this application, the input unit 1504 may include a Graphics Processing Unit (GPU) 15041 and a microphone 15042, and the graphics processing unit 15041 processes image data of a still picture or a video obtained by an image capture apparatus (such as a camera) in a video capture mode or an image capture mode. The display unit 1506 may include a display panel 15061, and the display panel 15061 may be configured in a form of a liquid crystal display, an organic light-emitting diode, or the like. The user input unit 1507 includes at least one of a touch panel 15071 and another input device 15072. The touch panel 15071 is also referred to as a touchscreen. The touch panel 15071 may include two parts: a touch detection apparatus and a touch controller. The another input device 15072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1501 may transmit the downlink data to the processor 1510 for processing. In addition, the radio frequency unit 1501 may send uplink data to the network side device. Generally, the radio frequency unit 1501 includes but is not limited to an antenna, an amplifier, a transceiver, a coupler, a low noise amplifier, a duplexer, and the like.

The memory 1509 may be configured to store a software program or an instruction and various data. The memory 1509 may mainly include a first storage area for storing a program or an instruction and a second storage area for storing data. The first storage area may store an operating system, and an application or an instruction required by at least one function (for example, a sound playing function or an image playing function). In addition, the memory 1509 may be a volatile memory or a non-volatile memory, or the memory 1509 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1509 in this embodiment of this application includes but is not limited to these memories and any memory of another proper type.

The processor 1510 may include one or more processing units. In some embodiments, an application processor and a modem processor are integrated into the processor 1510. The application processor mainly processes an operating system, a user interface, an application, or the like. The modem processor mainly processes a wireless communication signal, for example, a baseband processor. It may be understood that the modem processor may not be integrated into the processor 1510.

In an embodiment in which the terminal is the first terminal:
the radio frequency unit 1501 is configured to: receive a notification message sent by a first device, where the notification message is used to notify the first terminal of performing a sensing operation; and perform the sensing operation based on the notification message.

In some embodiments, the radio frequency unit 1501 is further configured to perform at least one of the following:
sending terminal information of the first terminal to the first device;
sending measurement information to the first device, where the measurement information is information obtained by the first terminal by measuring a received first signal; and
sending a second signal to the first device.

In some embodiments, the terminal information includes at least one of the following: location information, capability information, sensing subscription information, and state information;
and/or
the measurement information includes at least one of the following:
a communication-related indicator, a sensing-related indicator, a sensing measurement quantity, a sensing result, and a performance indicator of a target parameter.

In some embodiments, in a case that the first terminal is in an idle state or an inactive state, the first terminal enters a connected state to receive the first signal or send the second signal; or
the first terminal receives the first signal or sends the second signal in the idle state.

In some embodiments, the notification message includes at least one of the following:
configuration information of the second signal;
a sensing measurement quantity;
a sensing context; and
a threshold, where
the configuration information of the second signal includes at least one of the following: parameter information and resource information;
the sensing context includes at least one of the following: a sensing measurement quantity associated with a second terminal and a sensing result associated with the second terminal, where the second terminal is a sensing terminal that performs a sensing operation before the first terminal performs the sensing operation; and
the threshold is a discrimination threshold for sensing.

In some embodiments, the sensing operation includes one of the following:
receiving a first signal and feeding back a sensing measurement quantity related to the first signal;
sending a second signal; and
sending a second signal, receiving the second signal, and feeding back a sensing measurement quantity related to the second signal.

The first terminal may improve flexibility of sensing measurement.

In an embodiment in which the terminal is the first terminal:
the radio frequency unit 1501 is configured to: perform a sensing operation; and receive a notification message for stopping the sensing operation sent by a first device.

In some embodiments, the notification message is sent based on association information of the second terminal.

In some embodiments, the association information of the second terminal includes at least one of the following:
a measurement result that is of a first signal sent by the first device and that is reported by the second terminal;
sensing terminal change information reported by the second terminal;
a measurement result that is of a second signal sent by the second terminal and that is obtained by the first device; and
a measurement result of the second signal reported by the second terminal, where
the first signal includes at least one of a sensing signal, a reference signal, a synchronization signal, and a data signal; and the second signal includes at least one of a sensing signal, a reference signal, and a data signal.

In some embodiments, the radio frequency unit 1501 is further configured to:
receive first measurement configuration information sent by the first device, where
the first measurement configuration information includes at least one of the following:
a measurement object, where the measurement object includes configuration information of the first signal;
measurement report configuration information, where the measurement report configuration information includes at least one of the following: a reporting manner, a type of a reference signal used for measurement, and measurement report content; the reporting manner includes periodic reporting or reporting triggered by a measurement event; and the measurement report content includes at least one of the following: a communication-related indicator, a sensing-related indicator, a sensing measurement quantity, a sensing result, and a performance indicator of a target parameter; and
a measurement identifier, where one measurement identifier is used to associate at least one measurement object and at least one piece of the measurement report configuration information; and
in a case that the reporting manner includes reporting triggered by a measurement event, the first measurement configuration information further includes a measurement event.

In some embodiments, the measurement configuration information includes at least one of the following:
the measurement event includes at least one of the following:
at least one sensing-related indicator satisfies a first preset condition;
at least one sensing measurement quantity satisfies a second preset condition;
at least one sensing result satisfies a third preset condition;
at least one parameter of a sensing signal satisfies a fourth preset condition;
a state of a sensing target changes;
a location of the second terminal changes; and
at least one communication-related indicator of a non-serving cell and/or serving cell of the second terminal satisfies a fifth preset condition.

In some embodiments, the sensing-related indicator includes at least one of the following:
a sensing signal to noise ratio (SNR), a sensing signal to interference plus noise ratio (SINR), statistics on a plurality of measurement results of a sensing measurement quantity, deviation information between a predicted value and an actual measurement value of a sensing measurement quantity, deviation information between a predicted value and an actual measurement value of a measurement result, similar information of a signal sequence, and an echo signal power.

In some embodiments, the measurement result of the second signal is used to represent at least one of the following:
a communication-related indicator of the second signal received by the second terminal;
a sensing-related indicator of the second signal received by the second terminal;
a sensing measurement quantity obtained by the second terminal by using the received second signal;
a sensing result obtained by the second terminal by using the received second signal; and a performance indicator of a target parameter obtained by the second terminal by using the received second signal, where
the second signal is a signal sent and received by the second terminal.

In some embodiments, the target parameter includes at least one of the following:
a target parameter in a polar coordinate system and a target parameter in an inertial system; and
the performance indicator of the target parameter includes at least one of the following:
a variance of a residual of the target parameter, a standard deviation of a residual of the target parameter, a covariance of a prediction error of the target parameter, and a covariance of a state estimation error of the target parameter.

In some embodiments, the sensing terminal change information reported by the second terminal is reported by the second terminal based on at least one of the following:
power of the second terminal;
a service of the second terminal;
a physical state of the second terminal;
an orientation of the second terminal; and
a motion direction of the second terminal.

The second terminal may improve flexibility of sensing measurement.

An embodiment of this application further provides a readable storage medium. The readable storage medium stores a program or an instruction, and when the program or the instruction is executed by a processor, the processes of the foregoing sensing measurement method embodiment are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, the processor is configured to run a program or an instruction to implement the processes of the foregoing sensing measurement method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, the computer program/program product is executed by at least one processor to implement the processes of the foregoing sensing measurement method embodiment, and a same technical effect can be achieved. To avoid repetition, details are not described herein again.

An embodiment of this application also provides an information feedback system that includes a sensing measurement system, including a first device, a first terminal, and a second terminal, where the first device may be configured to perform the steps of the sensing measurement method on a first device side, the first terminal may be configured to perform the steps of the sensing measurement method on a first terminal side, and the second terminal may be configured to perform the steps of the sensing measurement method on a second terminal side.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for sensing measurement, comprising:
selecting, by a first device, a first terminal when a sensing terminal is determined to be changed; and
sending, by the first device, a notification message to the first terminal, wherein the notification message is used to notify the first terminal of performing a sensing operation.

2. The method according to claim 1, wherein the selecting, by a first device, a first terminal when a sensing terminal is determined to be changed comprises:
selecting the first terminal when the first device determines, based on association information of a second terminal, to change the sensing terminal,
wherein change of the sensing terminal comprises changing the second terminal to the first terminal.

3. The method according to claim 2, wherein the association information of the second terminal comprises at least one of the following:
a measurement result that is of a first signal sent by the first device and that is reported by the second terminal;
sensing terminal change information reported by the second terminal;
a measurement result that is of a second signal sent by the second terminal and that is obtained by the first device; or
a measurement result of the second signal reported by the second terminal,
wherein the first signal comprises at least one of a sensing signal, a reference signal, a synchronization signal, or a data signal; and the second signal comprises at least one of a sensing signal, a reference signal, or a data signal.

4. The method according to claim 3, further comprising:
sending, by the first device, first measurement configuration information to the second terminal,
wherein the first measurement configuration information comprises at least one of the following:
a measurement object, wherein the measurement object comprises configuration information of the first signal;
measurement report configuration information, wherein the measurement report configuration information comprises at least one of the following: a reporting manner, a type of a reference signal used for measurement, or measurement report content; the reporting manner comprises periodic reporting or reporting triggered by a measurement event; and the measurement report content comprises at least one of the following: a communication-related indicator, a sensing-related indicator, a sensing measurement quantity, a sensing result, or a performance indicator of a target parameter; or
a measurement identifier, wherein one measurement identifier is used to associate at least one measurement object and at least one piece of the measurement report configuration information; and
when the reporting manner comprises reporting triggered by a measurement event, the first measurement configuration information further comprises a measurement event.

5. The method according to claim 4, wherein the measurement event comprises at least one of the following:
at least one sensing-related indicator satisfies a first preset condition;
at least one sensing measurement quantity satisfies a second preset condition;
at least one sensing result satisfies a third preset condition;
at least one parameter of a sensing signal satisfies a fourth preset condition;
a state of a sensing target changes;
a location of the second terminal changes; or
at least one communication-related indicator of a non-serving cell or serving cell of the second terminal satisfies a fifth preset condition.

6. The method according to claim 5, wherein the sensing-related indicator comprises at least one of the following:
a sensing signal to noise ratio (SNR), a sensing signal to interference plus noise ratio (SINR), statistics on a plurality of measurement results of a sensing measurement quantity, deviation information between a predicted value and an actual measurement value of a sensing measurement quantity, deviation information between a predicted value and an actual measurement value of a measurement result, similar information of a signal sequence, or an echo signal power.

7. The method according to claim 3, wherein the measurement result of the second signal is used to represent at least one of the following:
a communication-related indicator of the second signal received by the second terminal;
a sensing-related indicator of the second signal received by the second terminal;
a sensing measurement quantity obtained by the second terminal by using the received second signal;
a sensing result obtained by the second terminal by using the received second signal; or
a performance indicator of a target parameter obtained by the second terminal by using the received second signal,
wherein the second signal is a signal sent and received by the second terminal.

8. The method according to claim 4, wherein the target parameter comprises at least one of the following:
a target parameter in a polar coordinate system and a target parameter in an inertial system; and
the performance indicator of the target parameter comprises at least one of the following:
a variance of a residual of the target parameter, a standard deviation of a residual of the target parameter, a covariance of a prediction error of the target parameter, or a covariance of a state estimation error of the target parameter.

9. The method according to claim 3, wherein the measurement result that is of the second signal sent by the second terminal and that is obtained by the first device is used to represent at least one of the following:
a communication-related indicator of the second signal received by the first device;
a sensing-related indicator of the second signal received by the first device;
a sensing measurement quantity obtained by the first device by using the received second signal;
a sensing result obtained by the first device by using the received second signal; or
a performance indicator of a target parameter obtained by the first device by using the received second signal,
wherein the second signal is a signal sent by the second terminal.

10. The method according to claim 1, wherein the selecting the first terminal comprises:
selecting, based on association information of a candidate terminal, the first terminal from the candidate terminal,
wherein the association information of the candidate terminal comprises at least one of the following:
terminal information of the candidate terminal;
measurement information of a first signal received by the candidate terminal; or
measurement information of a second signal sent by the candidate terminal.

11. The method according to claim 10, wherein the terminal information comprises at least one of the following:
location information, capability information, sensing subscription information, or state information; or
the measurement information comprises at least one of the following:
a communication-related indicator, a sensing-related indicator, a sensing measurement quantity, a sensing result, or a performance indicator of a target parameter.

12. The method according to claim 1, wherein the notification message comprises at least one of the following:
configuration information of the second signal;
a sensing measurement quantity;
a sensing context; or
a threshold, wherein:
the configuration information of the second signal comprises at least one of the following: parameter information or resource information;
the sensing context comprises at least one of the following: a sensing measurement quantity associated with the second terminal or a sensing result associated with the second terminal; and
the threshold is a discrimination threshold for sensing.

13. The method according to claim 2, further comprising at least one of the following:
sending, by the first device, a notification message for stopping the sensing operation to the second terminal;
obtaining, by the first device, a sensing measurement quantity for the sensing target based on a sensing measurement quantity associated with the second terminal and a sensing measurement quantity associated with the first terminal; or
obtaining, by the first device, a sensing result for the sensing target based on a sensing result associated with the second terminal and a sensing result associated with the first terminal.

14. The method according to claim 1, wherein the sensing operation comprises one of the following:
receiving a first signal and feeding back a sensing measurement quantity related to the first signal;
sending a second signal; or
sending a second signal, receiving the second signal, and feeding back a sensing measurement quantity related to the second signal.

15. A method for sensing measurement, comprising:
receiving, by a first terminal, a notification message sent by a first device, wherein the notification message is used to notify the first terminal of performing a sensing operation; and
performing, by the first terminal, the sensing operation based on the notification message.

16. The method according to claim 15, further comprising at least one of the following:
sending, by the first terminal, terminal information of the first terminal to the first device;
sending, by the first terminal, measurement information to the first device, wherein the measurement information is information obtained by the first terminal by measuring a received first signal; or
sending, by the first terminal, a second signal to the first device.

17. The method according to claim 16, wherein the terminal information comprises at least one of the following:
location information, capability information, sensing subscription information, or state information; or
the measurement information comprises at least one of the following:
a communication-related indicator, a sensing-related indicator, a sensing measurement quantity, a sensing result, or a performance indicator of a target parameter.

18. The method according to claim 15, wherein the notification message comprises at least one of the following:
configuration information of the second signal;
a sensing measurement quantity;
a sensing context; or
a threshold, wherein:
the configuration information of the second signal comprises at least one of the following: parameter information or resource information;
the sensing context comprises at least one of the following: a sensing measurement quantity associated with a second terminal or a sensing result associated with the second terminal, wherein the second terminal is a sensing terminal that performs a sensing operation before the first terminal performs the sensing operation; and
the threshold is a discrimination threshold for sensing.

19. The method according to claim 15, wherein the sensing operation comprises one of the following:
receiving a first signal and feeding back a sensing measurement quantity related to the first signal;
sending a second signal; or
sending a second signal, receiving the second signal, and feeding back a sensing measurement quantity related to the second signal.

20. A communication device, comprising: a memory storing a computer program; and a processor coupled to the memory and configured to execute the computer program to perform operations comprising:
selecting a first terminal when a sensing terminal is determined to be changed; and
sending a notification message to the first terminal, wherein the notification message is used to notify the first terminal of performing a sensing operation.
